(19) United States
(12) Patent Application Publication
(10) Pub. No.: US 2025/0056269 A1
(43) Pub. Date: Feb. 13, 2025

(54) CROSS-LINK INTERFERENCE MEASUREMENT TIMING FOR UPLINK AND DOWNLINK SUBBANDS

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US)

(21) Appl. No.: 18/448,851

(22) Filed: Aug. 11, 2023

(51) Int. Cl. H04W 24/08; H04B 17/345

(52) U.S. Cl. CPC H04W 24/08; H04B 17/345

(57) ABSTRACT

Methods, systems, and devices for wireless communications are described. A user equipment (UE) may transmit a capability message indicating that the UE supports performing inter-UE cross-link interference (CLI) measurements in an uplink subband and in at least one downlink subband during one or more overlapping subband full-duplex symbols. The UE may receive, based at least in part on the capability message, a measurement resource configuration for performing the inter-UE CLI measurements in the uplink subband and the at least one downlink subband. The UE may transmit, according to the measurement resource configuration, a measurement report message indicating a measurement result for the inter-UE CLI measurements.

### FIELD OF TECHNOLOGY

The following relates to wireless communications, including cross-link interference measurement timing for uplink and downlink subbands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross-link interference (CLI) measurement timing for uplink and downlink subbands. For example, the described techniques provide for various mechanisms to support a user equipment (UE) performing simultaneous CLI measurements in the uplink subband and/or in the downlink subband. One example may include the UE reporting its capability to support inter-UE CLI measurements in both the uplink subband and in the downlink subband during overlapping symbol(s). The UE may transmit a capability message to the network entity indicating the support, such as when the uplink timing and the downlink timing are different. For example, the UE may be equipped with or otherwise support multiple receive chains, where each receive chain performs the inter-UE CLI measurements in separate subbands. In some examples, separate measurement windows (e.g., fast-Fourier transform (FFT)) windows) may be used or otherwise configured for such inter-UE CLI measurements. The UE may receive an indication of a measurement resource configuration for the inter-UE CLI measurements and perform the inter-UE CLI measurements in both the uplink subband and the downlink subband during the overlapping symbol(s), such as overlapping subband full-duplex (SBFD) symbol(s). The UE may transmit a measurement report message to the network entity indicating the results of the inter-UE CLI measurements.

Additionally, or alternatively, the UE may not support simultaneous inter-UE CLI measurements in both the uplink and downlink subbands. The UE may still receive the indication of the measurements resource configuration and, in some examples, perform the inter-UE CLI measurements in the uplink subband and/or in the downlink subband. For example, the UE may use the uplink timing or the downlink timing when measuring the CLI in both the uplink and downlink subbands. In another example, the UE may drop the CLI measurements in the uplink subband or in the downlink subband based on the measurement resource configuration. In some examples, the UE may be subject to a scheduling constraint where the UE does not expect to receive the measurement resource configuration for simultaneous CLI measurements in both the uplink and downlink subbands. In this scenario, an error condition may be detected upon receiving such measurement resource configuration. The error condition may result in the UE not performing the inter-UE CLI measurements due to the error condition. When the UE is able to perform the CLI measurements according to the measurement resource configuration, the UE may again transmit a measurement report message to the network entity indicating the results of the inter-UE CLI measurements.

A method for wireless communications by a UE is described. The method may include transmitting a capability message indicating that the UE supports performing inter-UE CLI measurements in an uplink subband and in at least one downlink subband during one or more overlapping subband full-duplex symbols, receiving, based on the capability message, a measurement resource configuration for performing the inter-UE CLI measurements in the uplink subband and the at least one downlink subband, and transmitting, according to the measurement resource configuration, a measurement report message indicating a measurement result for the inter-UE CLI measurements.

A UE for wireless communications is described. The UE may include one or more memories storing processor executable code, and one or more processors coupled with the one or more memories. The one or more processors may individually or collectively operable to execute the code to cause the UE to transmit a capability message indicating that the UE supports performing inter-UE CLI measurements in an uplink subband and in at least one downlink subband during one or more overlapping subband full-duplex symbols, receive, based on the capability message, a measurement resource configuration for performing the inter-UE CLI measurements in the uplink subband and the at least one downlink subband, and transmit, according to the measurement resource configuration, a measurement report message indicating a measurement result for the inter-UE CLI measurements.

Another UE for wireless communications is described. The UE may include means for transmitting a capability message indicating that the UE supports performing inter-UE CLI measurements in an uplink subband and in at least one downlink subband during one or more overlapping subband full-duplex symbols, means for receiving, based on the capability message, a measurement resource configuration for performing the inter-UE CLI measurements in the uplink subband and the at least one downlink subband, and means for transmitting, according to the measurement resource configuration, a measurement report message indicating a measurement result for the inter-UE CLI measurements.

A non-transitory computer-readable medium storing code for wireless communications is described. The code may include instructions executable by a processor to transmit a capability message indicating that the UE supports performing inter-UE CLI measurements in an uplink subband and in at least one downlink subband during one or more overlapping subband full-duplex symbols, receive, based on the capability message, a measurement resource configuration for performing the inter-UE CLI measurements in the uplink subband and the at least one downlink subband, and transmit, according to the measurement resource configuration, a measurement report message indicating a measurement result for the inter-UE CLI measurements.

Some examples of the method, user equipment (UEs), and non-transitory computer-readable medium described herein may further include operations, features, means, or instructions for performing the inter-UE CLI measurements in the uplink subband and in the at least one downlink subband during the one or more overlapping subband full-duplex symbols to obtain the measurement result.

Some examples of the method, user equipment (UEs), and non-transitory computer-readable medium described herein may further include operations, features, means, or instructions for performing the inter-UE CLI measurements in the uplink subband may be in accordance with an uplink timing associated with the uplink subband and performing the inter-UE CLI measurements in the at least one downlink subband may be in accordance with a downlink timing associated with the at least one downlink subband, the uplink timing being different from the downlink timing.

Some examples of the method, user equipment (UEs), and non-transitory computer-readable medium described herein may further include operations, features, means, or instructions for performing the inter-UE CLI measurements in the uplink subband and in the at least one downlink subband may be in accordance with one or more measurement windows associated with the uplink subband and the at least one downlink subband.

In some examples of the method, user equipment (UEs), and non-transitory computer-readable medium described herein, the one or more overlapping subband full-duplex symbols may be associated with subband full-duplex communications using the uplink subband and the at least one downlink subband.

A method for wireless communications by a UE is described. The method may include receiving measurement resource configuration for performing inter-UE CLI measurements during one or more overlapping subband full-duplex symbols and in an uplink subband associated with an uplink timing and in at least one downlink subband associated with a downlink timing that is different from the uplink timing, performing, in accordance with the measurement resource configuration, the inter-UE CLI measurements in the uplink subband, in the at least one downlink subband, or both, according to the uplink timing or to the downlink timing to obtain a measurement result, and transmitting a measurement report message indicating the measurement result for the inter-UE CLI measurements.

A UE for wireless communications is described. The UE may include one or more memories storing processor executable code, and one or more processors coupled with the one or more memories. The one or more processors may individually or collectively operable to execute the code to cause the UE to receive measurement resource configuration for performing inter-UE CLI measurements during one or more overlapping subband full-duplex symbols and in an uplink subband associated with an uplink timing and in at least one downlink subband associated with a downlink timing that is different from the uplink timing, perform, in accordance with the measurement resource configuration, the inter-UE CLI measurements in the uplink subband, in the at least one downlink subband, or both, according to the uplink timing or to the downlink timing to obtain a measurement result, and transmit a measurement report message indicating the measurement result for the inter-UE CLI measurements.

Another UE for wireless communications is described. The UE may include means for receiving measurement resource configuration for performing inter-UE CLI measurements during one or more overlapping subband full-duplex symbols and in an uplink subband associated with an uplink timing and in at least one downlink subband associated with a downlink timing that is different from the uplink timing, means for performing, in accordance with the measurement resource configuration, the inter-UE CLI measurements in the uplink subband, in the at least one downlink subband, or both, according to the uplink timing or to the downlink timing to obtain a measurement result, and means for transmitting a measurement report message indicating the measurement result for the inter-UE CLI measurements.

A non-transitory computer-readable medium storing code for wireless communications is described. The code may include instructions executable by a processor to receive measurement resource configuration for performing inter-UE CLI measurements during one or more overlapping subband full-duplex symbols and in an uplink subband associated with an uplink timing and in at least one downlink subband associated with a downlink timing that is different from the uplink timing, perform, in accordance with the measurement resource configuration, the inter-UE CLI measurements in the uplink subband, in the at least one downlink subband, or both, according to the uplink timing or to the downlink timing to obtain a measurement result, and transmit a measurement report message indicating the measurement result for the inter-UE CLI measurements.

In some examples of the method, user equipment (UEs), and non-transitory computer-readable medium described herein, performing the inter-UE CLI measurements may include operations, features, means, or instructions for performing the inter-UE CLI measurements in the uplink subband and in the at least one downlink subband according to the uplink timing.

In some examples of the method, user equipment (UEs), and non-transitory computer-readable medium described herein, switching, during a set of preceding gap symbols, from the downlink timing to the uplink timing to perform the inter-UE CLI measurements in the uplink subband and in the at least one downlink subband.

In some examples of the method, user equipment (UEs), and non-transitory computer-readable medium described herein, performing the inter-UE CLI measurements may include operations, features, means, or instructions for measuring, using the uplink timing, a first reference signal strength indicator (RSSI) in the at least one downlink subband, a reference signal receive power (RSRP) in the uplink subband, a second RSSI in the uplink subband, or a combination thereof.

Some examples of the method, user equipment (UEs), and non-transitory computer-readable medium described herein may further include operations, features, means, or instructions for performing the inter-UE CLI measurements according to the uplink timing may be based on a timing rule associated with the UE.

In some examples of the method, user equipment (UEs), and non-transitory computer-readable medium described herein, performing the inter-UE CLI measurements may include operations, features, means, or instructions for performing the inter-UE CLI measurements in the uplink subband and in the at least one downlink subband according to the downlink timing.

In some examples of the method, user equipment (UEs), and non-transitory computer-readable medium described herein, switching, during a set of trailing gap symbols, from the uplink timing to the downlink timing to perform the inter-UE CLI measurements in the uplink subband and in the at least one downlink subband.

In some examples of the method, user equipment (UEs), and non-transitory computer-readable medium described herein, performing the inter-UE CLI measurements may include operations, features, means, or instructions for measuring, using the downlink timing, a first RSSI in the at least one downlink subband, a second RSSI in the uplink subband, or a combination thereof.

In some examples of the method, user equipment (UEs), and non-transitory computer-readable medium described herein, a set of preceding gap symbols may be removed in accordance with performing the inter-UE CLI measurements according to the downlink timing.

Some examples of the method, user equipment (UEs), and non-transitory computer-readable medium described herein may further include operations, features, means, or instructions for performing the inter-UE CLI measurements according to the downlink timing may be based on a timing rule associated with the UE.

In some examples of the method, user equipment (UEs), and non-transitory computer-readable medium described herein, performing the inter-UE CLI measurements may include operations, features, means, or instructions for dropping the inter-UE CLI measurements in the at least one downlink subband in accordance with the downlink timing being different from the uplink timing and performing the inter-UE CLI measurements in the uplink subband according to the uplink timing.

In some examples of the method, user equipment (UEs), and non-transitory computer-readable medium described herein, performing the inter-UE CLI measurements may include operations, features, means, or instructions for measuring, using the uplink timing and in accordance with the dropping, a RSRP in the uplink subband, a RSSI in the uplink subband, or a combination thereof.

Some examples of the method, user equipment (UEs), and non-transitory computer-readable medium described herein may further include operations, features, means, or instructions for dropping the inter-UE CLI measurements in the at least one downlink subband may be based on a dropping rule associated with the UE.

In some examples of the method, user equipment (UEs), and non-transitory computer-readable medium described herein, performing the inter-UE CLI measurements may include operations, features, means, or instructions for dropping the inter-UE CLI measurements in the uplink subband in accordance with the downlink timing being different from the uplink timing and performing the inter-UE CLI measurements in the at least one downlink subband according to the downlink timing.

In some examples of the method, user equipment (UEs), and non-transitory computer-readable medium described herein, performing the inter-UE CLI measurements may include operations, features, means, or instructions for measuring, using the downlink timing and in accordance with the dropping, a RSSI in the at least one downlink subband.

Some examples of the method, user equipment (UEs), and non-transitory computer-readable medium described herein may further include operations, features, means, or instructions for dropping the inter-UE CLI measurements in the uplink subband may be based on a dropping rule associated with the UE.

In some examples of the method, user equipment (UEs), and non-transitory computer-readable medium described herein, performing the inter-UE CLI measurements may include operations, features, means, or instructions for detecting an error state in accordance with the measurement resource configuration being received for inter-UE CLI measurements in the uplink subband and the at least one downlink subband during the one or more overlapping subband full-duplex symbols, the error state corresponding to an expectation that the UE may be not to receive the measurement resource configuration for performing simultaneous inter-UE CLI measurements in the uplink subband and in the at least one downlink subband during the one or more overlapping subband full-duplex symbols, where performing the inter-UE CLI measurements and transmitting the measurement report message may be in accordance with the error state.

In some examples of the method, user equipment (UEs), and non-transitory computer-readable medium described herein, performing the inter-UE CLI measurements may include operations, features, means, or instructions for dropping the measurement resource configuration in accordance with an expectation that the UE may be not to receive CLI measurements in the uplink subband and in the at least one downlink subband during the one or more overlapping subband full-duplex symbols, where performing the inter-UE CLI measurements and transmitting the measurement report message may be in accordance with the dropping.

In some examples of the method, user equipment (UEs), and non-transitory computer-readable medium described herein, performing the inter-UE CLI measurements may include operations, features, means, or instructions for receiving an indication to drop the inter-UE CLI measurements in the uplink subband or in the at least one downlink subband, the indication in accordance with the UE not supporting simultaneous CLI measurements in the uplink subband and in the at least one downlink subband during the one or more overlapping subband full-duplex symbols.

In some examples of the method, user equipment (UEs), and non-transitory computer-readable medium described herein, performing the inter-UE CLI measurements may include operations, features, means, or instructions for receiving an indication to use the uplink timing or the downlink timing for the inter-UE CLI measurements in the uplink subband, in the at least one downlink subband, or both, the indication in accordance with the UE not supporting simultaneous inter-UE CLI measurements in the uplink subband and in the at least one downlink subband during the one or more overlapping subband full-duplex symbols.

Some examples of the method, user equipment (UEs), and non-transitory computer-readable medium described herein may further include operations, features, means, or instructions for identifying an overlap between one or more uplink subband measurement instances and one or more downlink subband measurement instances according to the measurement resource configuration, where performing the inter-UE CLI measurements in the uplink subband, in the at least one downlink subband, or both, may be in accordance with the overlap.

Some examples of the method, user equipment (UEs), and non-transitory computer-readable medium described herein may further include operations, features, means, or instructions for identifying a first periodicity for the inter-UE CLI measurements in the uplink subband and a second periodicity for the inter-UE CLI measurements in the at least one downlink subband, where the overlap may be in accordance with the first periodicity and the second periodicity.

A method for wireless communications by a network entity is described. The method may include receiving, from a UE, a capability message indicating that the UE supports performing inter-UE CLI measurements in an uplink subband and in at least one downlink subband during one or more overlapping subband full-duplex symbols, transmitting, based on the capability message, a measurement resource configuration for the UE to perform the inter-UE CLI measurements in the uplink subband and in the at least one downlink subband, and receiving, according to the measurement resource configuration, a measurement report message indicating a measurement result for the inter-UE CLI measurements.

A network entity for wireless communications is described. The network entity may include one or more memories storing processor executable code, and one or more processors coupled with the one or more memories. The one or more processors may individually or collectively operable to execute the code to cause the network entity to receive, from a UE, a capability message indicating that the UE supports performing inter-UE CLI measurements in an uplink subband and in at least one downlink subband during one or more overlapping subband full-duplex symbols, transmit, based on the capability message, a measurement resource configuration for the UE to perform the inter-UE CLI measurements in the uplink subband and in the at least one downlink subband, and receive, according to the measurement resource configuration, a measurement report message indicating a measurement result for the inter-UE CLI measurements.

Another network entity for wireless communications is described. The network entity may include means for receiving, from a UE, a capability message indicating that the UE supports performing inter-UE CLI measurements in an uplink subband and in at least one downlink subband during one or more overlapping subband full-duplex symbols, means for transmitting, based on the capability message, a measurement resource configuration for the UE to perform the inter-UE CLI measurements in the uplink subband and in the at least one downlink subband, and means for receiving, according to the measurement resource configuration, a measurement report message indicating a measurement result for the inter-UE CLI measurements.

A non-transitory computer-readable medium storing code for wireless communications is described. The code may include instructions executable by a processor to receive, from a UE, a capability message indicating that the UE supports performing inter-UE CLI measurements in an uplink subband and in at least one downlink subband during one or more overlapping subband full-duplex symbols, transmit, based on the capability message, a measurement resource configuration for the UE to perform the inter-UE CLI measurements in the uplink subband and in the at least one downlink subband, and receive, according to the measurement resource configuration, a measurement report message indicating a measurement result for the inter-UE CLI measurements.

In some examples of the method, network entities, and non-transitory computer-readable medium described herein, the inter-UE CLI measurements in the uplink subband may be in accordance with an uplink timing associated with the uplink subband and performing the inter-UE CLI measurements in the at least one downlink subband may be in accordance with a downlink timing associated with the at least one downlink subband, the uplink timing being different from the downlink timing.

In some examples of the method, network entities, and non-transitory computer-readable medium described herein, the inter-UE CLI measurements in the uplink subband and in the at least one downlink subband may be in accordance with one or more measurement windows associated with the uplink subband and the at least one downlink subband.

A method for wireless communications by a network entity is described. The method may include transmitting, to a UE, a measurement resource configuration for the UE to perform inter-UE CLI measurements during one or more overlapping subband full-duplex symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing and receiving a measurement report message indicating a measurement result for the inter-UE CLI measurements.

A network entity for wireless communications is described. The network entity may include one or more memories storing processor executable code, and one or more processors coupled with the one or more memories. The one or more processors may individually or collectively operable to execute the code to cause the network entity to transmit, to a UE, a measurement resource configuration for the UE to perform inter-UE CLI measurements during one or more overlapping subband full-duplex symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing and receive a measurement report message indicating a measurement result for the inter-UE CLI measurements.

Another network entity for wireless communications is described. The network entity may include means for transmitting, to a UE, a measurement resource configuration for the UE to perform inter-UE CLI measurements during one or more overlapping subband full-duplex symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing and means for receiving a measurement report message indicating a measurement result for the inter-UE CLI measurements.

A non-transitory computer-readable medium storing code for wireless communications is described. The code may include instructions executable by a processor to transmit, to a UE, a measurement resource configuration for the UE to perform inter-UE CLI measurements during one or more overlapping subband full-duplex symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing and receive a measurement report message indicating a measurement result for the inter-UE CLI measurements.

Some examples of the method, network entities, and non-transitory computer-readable medium described herein may further include operations, features, means, or instructions for allocating a set of preceding gap symbols before the one or more overlapping subband full-duplex symbols for the UE to switch from the downlink timing to the uplink timing to perform the inter-UE CLI measurements in the uplink subband and in the at least one downlink subband.

Some examples of the method, network entities, and non-transitory computer-readable medium described herein may further include operations, features, means, or instructions for allocating a set of trailing gap symbols before the one or more overlapping subband full-duplex symbols for the UE to switch from the uplink timing to the downlink timing to perform the inter-UE CLI measurements in the uplink subband and in the at least one downlink subband.

Some examples of the method, network entities, and non-transitory computer-readable medium described herein may further include operations, features, means, or instructions for removing a set of preceding gap symbols in accordance with the UE performing the inter-UE CLI measurements according to the downlink timing.

Some examples of the method, network entities, and non-transitory computer-readable medium described herein may further include operations, features, means, or instructions for detecting an error state in accordance with the measurement resource configuration being transmitted for inter-UE CLI measurements in the uplink subband and in the at least one downlink subband during the one or more overlapping subband full-duplex symbols, the error state corresponding to an expectation that the UE may be not to receive the measurement resource configuration for performing simultaneous inter-UE CLI measurements in the uplink subband and in the at least one downlink subband during the one or more overlapping subband full-duplex symbols.

Some examples of the method, network entities, and non-transitory computer-readable medium described herein may further include operations, features, means, or instructions for dropping the measurement resource configuration in accordance with an expectation that the UE may be not to receive the measurement resource configuration for performing the inter-UE CLI measurements in the uplink subband and in the at least one downlink subband during the one or more overlapping subband full-duplex symbols.

Some examples of the method, network entities, and non-transitory computer-readable medium described herein may further include operations, features, means, or instructions for transmitting an indication for the UE to drop the inter-UE CLI measurements in the uplink subband or in the at least one downlink subband, the indication in accordance with an expectation that the UE may be not to receive the measurement resource configuration for performing the inter-UE CLI measurements in the uplink subband and in the at least one downlink subband during the one or more overlapping subband full-duplex symbols.

Some examples of the method, network entities, and non-transitory computer-readable medium described herein may further include operations, features, means, or instructions for transmitting an indication for the UE to use the uplink timing or the downlink timing for the inter-UE CLI measurements in the uplink subband, in the at least one downlink subband, or both, the indication in accordance with the UE not supporting simultaneous CLI measurements in the uplink subband and in the at least one downlink subband during the one or more overlapping subband full-duplex symbols.

Some examples of the method, network entities, and non-transitory computer-readable medium described herein may further include operations, features, means, or instructions for identifying an overlap between one or more uplink subband measurement instances and one or more downlink subband measurement instances according to the measurement resource configuration, where the UE performing the inter-UE CLI measurements in the uplink subband, in the at least one downlink subband, or both, may be in accordance with the overlap.

Some examples of the method, network entities, and non-transitory computer-readable medium described herein may further include operations, features, means, or instructions for identifying a first periodicity for the inter-UE CLI measurements in the uplink subband and a second periodicity for the inter-UE CLI measurements in the at least one downlink subband, where the overlap may be in accordance with the first periodicity and the second periodicity.

### BRIEF DESCRIPTION OF THE DRAWINGS

FIG. 1 shows an example of a wireless communications system that supports cross-link interference (CLI) measurement timing for uplink and downlink subbands in accordance with one or more aspects of the present disclosure.

FIG. 2 shows an example of a wireless communications system that supports CLI measurement timing for uplink and downlink subbands in accordance with one or more aspects of the present disclosure.

FIGS. 3A and 3B show examples of a SBFD configuration that supports CLI measurement timing for uplink and downlink subbands in accordance with one or more aspects of the present disclosure.

FIGS. 4A and 4B show examples of a SBFD configuration that supports CLI measurement timing for uplink and downlink subbands in accordance with one or more aspects of the present disclosure.

FIGS. 5 and 6 show block diagrams of devices that support CLI measurement timing for uplink and downlink subbands in accordance with one or more aspects of the present disclosure.

FIG. 7 shows a block diagram of a communications manager that supports CLI measurement timing for uplink and downlink subbands in accordance with one or more aspects of the present disclosure.

FIG. 8 shows a diagram of a system including a device that supports CLI measurement timing for uplink and downlink subbands in accordance with one or more aspects of the present disclosure.

FIGS. 9 and 10 show block diagrams of devices that support CLI measurement timing for uplink and downlink subbands in accordance with one or more aspects of the present disclosure.

FIG. 11 shows a block diagram of a communications manager that supports CLI measurement timing for uplink and downlink subbands in accordance with one or more aspects of the present disclosure.

FIG. 12 shows a diagram of a system including a device that supports CLI measurement timing for uplink and downlink subbands in accordance with one or more aspects of the present disclosure.

FIGS. 13 through 16 show flowcharts illustrating methods that support CLI measurement timing for uplink and downlink subbands in accordance with one or more aspects of the present disclosure.

### DETAILED DESCRIPTION

Wireless networks may use subband full-duplex (SBFD) symbol(s)/slot(s) where an allocated bandwidth is divided into uplink and downlink subbands. The SBFD allocation enables full-duplex communications between a network entity and one or more user equipment (UE). For example, the network entity may be receiving an uplink transmission from a first UE while, at the same time, transmitting a downlink transmission to a second UE. However, this may introduce cross-link interference (CLI) into the wireless medium, such as inter-UE CLI. To mitigate such inter-UE CLI, CLI measurement and reporting may be scheduled for the victim UE within the bandwidth. Such CLI measurement and reporting may include the UE performing CLI measurements in the uplink subband as well as in the downlink subband (e.g., during overlapping symbol(s)). For example, the uplink timing advance may be different from the downlink timing advance of the UE. Wireless networks conventionally do not provide a mechanism to support a UE being configured with simultaneous CLI measurements in the uplink subband and in the downlink subband.

The described techniques relate to improved methods, systems, devices, and apparatuses that support CLI measurement timing for uplink and downlink subbands. For example, the described techniques provide for various mechanisms to support a UE performing simultaneous CLI measurements in the uplink subband and/or in the downlink subband. One example may include the UE reporting its capability to support inter-UE CLI measurements in both the uplink subband and in the downlink subband during overlapping symbol(s). The UE may transmit a capability message to the network entity indicating the support, such as when the uplink timing and the downlink timing are different. For example, the UE may be equipped with or otherwise support multiple receive chains, such that each receive chain performs the inter-UE CLI measurements in separate subbands. In some examples, separate measurement windows (e.g., fast-Fourier transform (FFT)) windows) may be used or otherwise configured for such inter-UE CLI measurements. The UE may receive an indication of a measurement resource configuration for the inter-UE CLI measurements and perform the inter-UE CLI measurements in both the uplink subband and the downlink subband during the overlapping symbol(s), such as overlapping SBFD symbol(s). The UE may transmit a measurement report message to the network entity indicating the results of the inter-UE CLI measurements.

Additionally, or alternatively, the UE may not support simultaneous inter-UE CLI measurements in both the uplink and downlink subbands. The UE may still receive the indication of the measurements resource configuration and, in some examples, perform the inter-UE CLI measurements in the uplink subband and/or in the downlink subband. For example, the UE may use the uplink timing or the downlink timing when measuring the CLI in both the uplink and downlink subbands. In another example, the UE may drop the CLI measurements in the uplink subband or in the downlink subband based on the measurement resource configuration. In some examples, the UE may be subject to a scheduling constraint where the UE does not expect to receive the measurement resource configuration for simultaneous CLI measurements in both the uplink and downlink subbands. In this scenario, an error condition may be detected upon receiving such measurement resource configuration. The error condition may result in the UE not performing the inter-UE CLI measurements due to the error condition. When the UE is able to perform the CLI measurements according to the measurement resource configuration, the UE may again transmit a measurement report message to the network entity indicating the results of the inter-UE CLI measurements.

Aspects of the disclosure are initially described in the context of wireless communications systems. Aspects of the disclosure are further illustrated by and described with reference to apparatus diagrams, system diagrams, and flowcharts that relate to cross-link interference measurement timing for uplink and downlink subbands.

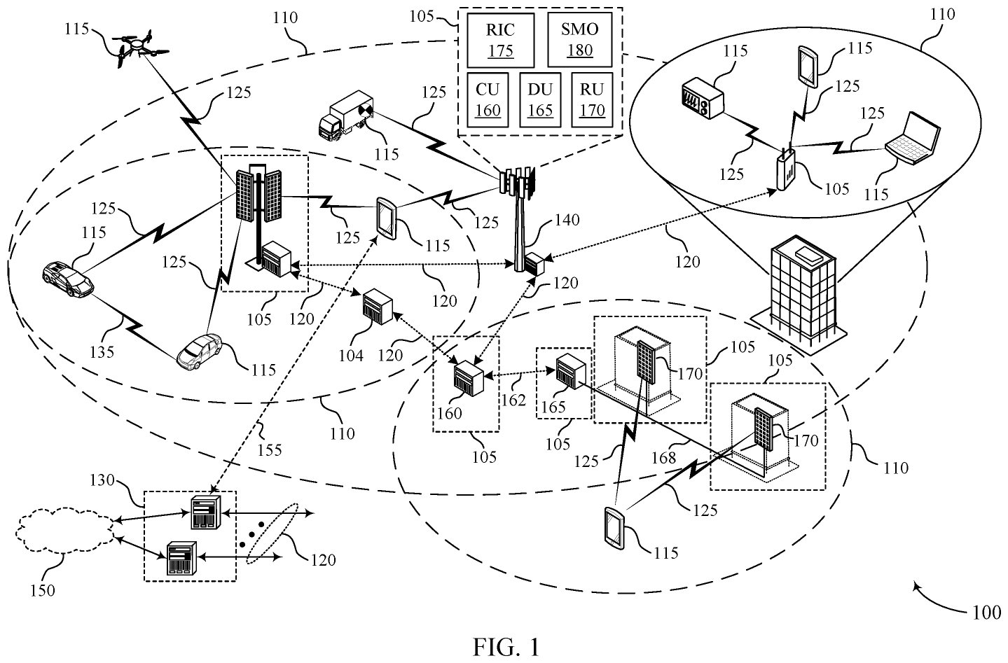

FIG. 1 shows an example of a wireless communications system 100 that supports cross-link interference measurement timing for uplink and downlink subbands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support cross-link interference measurement timing for uplink and downlink subbands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit a capability message indicating that the UE supports performing inter-UE CLI measurements in an uplink subband and in at least one downlink subband during one or more overlapping SBFD symbols. The UE 115 may receive, based at least in part on the capability message, a measurement resource configuration for performing the inter-UE CLI measurements in the uplink subband and the at least one downlink subband. The UE 115 may transmit, according to the measurement resource configuration, a measurement report message indicating a measurement result for the inter-UE CLI measurements.

A UE 115 may receive a measurement resource configuration for performing inter-UE CLI measurements during one or more overlapping SBFD symbols and in an uplink subband associated with an uplink timing and in at least one downlink subband associated with a downlink timing that is different from the uplink timing. The UE 115 may perform, in accordance with the measurement resource configuration, the inter-UE CLI measurements in the uplink subband, in the at least one downlink subband, or both, according to the uplink timing or to the downlink timing to obtain a measurement result. The UE 115 may transmit a measurement report message indicating the measurement result for the inter-UE CLI measurements.

A network entity 105 may receive, from a UE 115, a capability message indicating that the UE 115 supports performing inter-UE CLI measurements in an uplink subband and in at least one downlink subband during one or more overlapping SBFD symbols. The network entity 105 may transmit, based at least in part on the capability message, a measurement resource configuration for the UE 115 to perform the inter-UE CLI measurements in the uplink subband and in the at least one downlink subband. The network entity 105 may receive, according to the measurement resource configuration, a measurement report message indicating a measurement result for the inter-UE CLI measurements.

A network entity 105 may transmit, to a UE 115, a measurement resource configuration for the UE 115 to perform inter-UE CLI measurements during one or more overlapping SBFD symbols and in an uplink subband associated with an uplink timing and in at least one downlink subband associated with a downlink timing that is different from the uplink timing, wherein the UE performs the inter-UE CLI measurements in the uplink subband, in the at least one downlink subband, or both, according to the uplink timing or to the downlink timing. The network entity 105 may receive a measurement report message indicating a measurement result for the inter-UE CLI measurements.

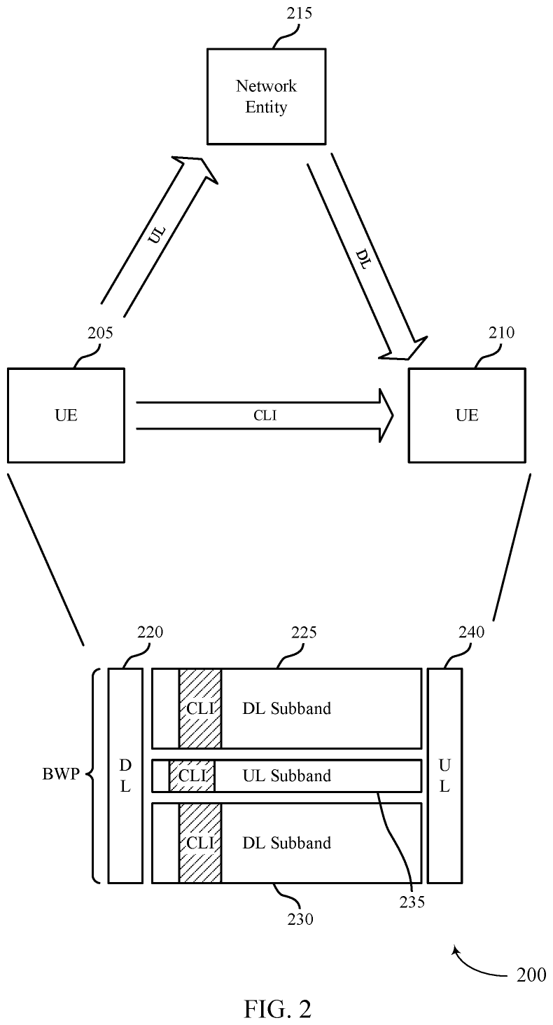

FIG. 2 shows an example of a wireless communications system 200 that supports CLI measurement timing for uplink and downlink subbands in accordance with one or more aspects of the present disclosure. Wireless communications system 200 may implement aspects of wireless communications system 100. Wireless communications system 200 may include a UE 205, a UE 210, and a network entity 215, which may be examples of the corresponding devices described herein. The UE 205 may be considered an aggressor UE and the UE 210 may be considered a victim UE, such as when uplink transmissions from the UE 205 introduce or contribute to CLI for the UE 210.

Wireless communications system 200 may support SBFD communications techniques. For example, the bandwidth allocated to or otherwise associated with communications across the wireless medium are subdivided into different subbands. For example, the UE 205 and/or the UE 210 may be associated with a BWP defining the frequency resources (e.g., in the frequency domain and shown along the vertical axis) within which the UE can perform wireless communications. The BWP may be allocated for one or more symbols and/or slots (e.g., in the time domain and shown along the horizontal axis), which may also be referred to as SBFD symbol(s) and/or slot(s). Initially (e.g., during the first few BFD symbol(s)), the frequency resources of the BWP may be allocated for downlink communications 220, such as for communicating downlink control channel signals. However, the frequency resources of the BWP may then be divided or otherwise allocated into different subbands for most of the SBFD slot. In the non-limiting example shown in FIG. 2, this may include the frequency resources being divided into two downlink subbands (e.g., downlink subband 225 and downlink subband 230) and one uplink subband 235. The uplink subband 235 may be located or otherwise allocated between the two downlink subbands, with gap frequencies between the uplink and downlink subbands. It is to be understood that the SBFD BWP may be divided or otherwise allocated to a different configuration of subbands containing at least one uplink subband and at least one downlink subband. The final period (e.g., the final few symbol(s)) of the SBFD slot) may be allocated for uplink communications (e.g., uplink 240), such as for transmitting feedback messages, scheduling requests, or other uplink control channel messages.

Allocating the frequency resources of the BWP into uplink and downlink subbands may support, among other advantages, duplex operations. As one non-limiting example shown in FIG. 2, this may enable the network entity 215 to perform full duplex communications with one or more UEs. For example, the network entity 215 may be transmitting a downlink signal to the UE 210 using the downlink subband 225 and/or downlink subband 230 while, at the same time, receiving an uplink signal from the UE 205 using the uplink subband 235 of the BWP. This may include the network entity 215 performing full-duplex communications (e.g., transmitting and receiving at the same time) and the UEs (e.g., UE 205 and/or UE 210) performing half-duplex communications (e.g., either transmitting or receiving at a given time).

Such SBFD techniques may also support dynamic enhancements for dynamic/flexible TDD operations within the wireless network. More particularly, such SBFD techniques may increase the uplink duty cycle for wireless communications. This may result in a latency reduction (e.g., it is possible to transmit an uplink signal in uplink subband 235 during downlink only or flexible slots or receive a downlink signal in downlink subband(s) in legacy uplink only slots). This may improve uplink coverage within the wireless network, enhance system capacity, resource utilization, and spectrum efficiency, and enable flexible and dynamic uplink/downlink resource adaption according to uplink/downlink traffic in a more robust manner.

One concern associated with such SBFD techniques is CLI, which is generally considered the interference introduced or enhanced when a wireless link from one device (e.g., the uplink transmissions from the UE 205, in this example) interferes with the wireless link of another device (e.g., the downlink reception at the UE 210, in this example). That is, the UE 205 and the UE 210 may be located within a proximate threshold range of each other such that the uplink transmission from the UE 205 has sufficient strength to interference with the ability of the UE 210 to receive the downlink transmission from the network entity 215. The UEs in this example may be located within the same cell (e.g., intra-cell CLI) or may be associated with different cells (e.g., inter-cell CLI). The CLI introduced by such transmissions may also be referred to as inter-UE CLI.

To address inter-UE CLI, different methods may be applied within the wireless communications system 200 to support inter-UE inter-subband CLI measurements and reporting. One method may include the victim UE (e.g., the UE 210, in this example) measuring the reference signal strength indicator (RSSI) within the downlink subband(s). The RSSI may be measured, obtained, or otherwise determined based on the UE 210 measuring the signal strength of any signal detected within the subband. Another method may include the victim UE measuring the reference signal received power (RSRP) of the aggressor UE (e.g., the UE 205, in this example) within the uplink subband (e.g., uplink subband 235). Unlike the RSSI that is measured using any signal detected within the subband, the RSSP measurement generally include the aggressor UE transmitting a sounding reference signal (SRS) that is measured by the victim UE. The SRS transmission may involve various messages exchanged between the UEs (e.g., to configure the timing and/or other resources associated with the SRS transmission within the uplink subband). Yet another method may include the victim UE measuring the RSSI within the uplink subband. Again, the RSSI may be measured using any signal within the subband.

Moreover, inter-UE CLI measurements during a SBFD slot according to the first method above may be based, at least to some degree, on whether or not the SBFD slot includes one or two downlink subbands (e.g., how to perform RSSI measurements of two non-contiguous downlink subbands). One technique may include separate CLI-RSSI measurement resources/reports being configured for each downlink subband (e.g., separately for downlink subband 225 and for downlink subband 230). Another technique may include CLI-RSSI measurement/reporting in one of the downlink subbands (e.g., in either downlink subband 225 or in downlink subband 230). Yet another technique may include CLI-RSSI measurement/reporting based on a non-contiguous CLI-RSSI resource across both downlink subbands. That is, this technique monitors the full BWP to determine the CLI-RSSI of a downlink subband.

Accordingly, wireless communications system 200 may support the victim UE measuring the RSSI or RSRP of the aggressor UE in the uplink subband and/or measuring the RSSI of the aggressor UE within the downlink subband. This may enable the network entity 215 to configure the victim UE to measure the CLI in the uplink subband 235 ((e.g., for in-band blocking) and within the downlink subband(s) (e.g., for CLI leakage) in the same or in different SBFD symbol(s). When the network entity 215 configures the UE 210 to simultaneously measure CLI in the uplink subband and at least one downlink subband in the same SBFD symbol(s), this may be considered a frequency domain multiplexed (FDMed) CLI measurement in the same SBFD symbol(s).

However, uplink communications between the network entity 215 and UE are based on an uplink timing advance (e.g., uplink timing). The uplink timing generally synchronizes the UE and the network entity 215 in the time domain based on the uplink channel/propagation path. This may enable configuring time resource allocations for the communications so the UE knows when to transmit an uplink signal and the network entity 215 knows (e.g., based on the uplink timing advance) when to monitor for the uplink signal. Similarly, downlink communications between the network entity 215 and UE are based on a downlink timing advance (e.g., downlink timing). The downlink timing again synchronizes the UE and the network entity 215 in the time domain based on the downlink channel/propagation path. Due to differences between the uplink channel and the downlink channel, the uplink timing and the downlink timing are generally different. That is, the uplink timing advance is not the same as the downlink timing advance. Generally, the uplink timing advance may mean that uplink signals are transmitted before downlink signals (e.g., the uplink timing advance is more than the downlink timing advance, in some examples). This may create difficulties a UE is configured with a measurement resource configuration for inter-UE CLI measurements simultaneously in both the uplink subband and the downlink subband(s).

Accordingly, aspects of the techniques described herein provide various mechanisms to address the victim UE being configured with FDMed simultaneous inter-UE CLI measurements. One example may include the victim UE supporting simultaneous inter-UE CLI measurements in both the uplink subband 235 and one or both downlink subbands (e.g., downlink subband 225 and/or downlink subband 230).

For example, the UE 210 (the victim UE, in this example) may transmit or otherwise provide (and the network entity 215 may receive or otherwise obtain) a capability message indicating that the UE 210 supports performing inter-UE CLI measurements in an uplink subband and in at least one downlink subband during overlapping SBFD symbol(s). The capability message may be transmitted in a UE capability message, in an assistance information message, or in any uplink control message received by the network entity 215.

The capability message may carry or otherwise convey information indicating such support by the UE 210 using bit(s), field(s), or other information (implicitly and/or explicitly). The UE 210 may also be an “SBFD aware UE” in that the UE 210 supports SBFD-based communications where the BWP (e.g., the downlink BWP) has been divided into downlink subband 225, downlink subband 230, and uplink subband 235. Again, the downlink subbands may be separated from the uplink subband 235 by a guard band (e.g., to prevent subband leakage).

In some examples, this may include the UE 210 supporting such simultaneous inter-UE CLI measurements in both the uplink subband 235 and in at least one of the downlink subbands using separate receive chains. For example, the UE 210 may be equipped with at least two receive chains or paths that enable the UE 210 to tune one receiver to the uplink subband 235 and to tune the other receiver to at least one downlink subband. As separate receivers are used, this may enable the UE 210 to measure the RSSI within the downlink subband using the downlink timing and to measure the RSSI or RSRP within the uplink subband 235 using the uplink timing. That is, the timing difference between the uplink and downlink timing advances may be mitigated based on the UE 210 supporting the simultaneous inter-UE CLI measurements. In some examples, different FFT windows (e.g., measurement windows) may be used for the FDMed inter-UE CLI measurements in the uplink and downlink subbands.

Accordingly, the network entity 215 may transmit or otherwise provide (and the UE 210 may receive or otherwise obtain) a measurement resource configuration for performing the inter-UE CLI measurements in the uplink subband 235 and in at least one of the downlink subbands during overlapping SBFD symbol(s). The measurement resource configuration may generally identify, define, or otherwise allocate resources and/or parameters to be applied for performing the inter-UE CLI measurements.

The UE 210 may perform, according to the measurement resource configuration, the inter-UE CLI measurements during the overlapping SBFD symbol(s) and in the uplink subband 235 according to the uplink timing and in at least one of the downlink subbands (e.g., in downlink subband 225 and/or in downlink subband 230) according to the downlink timing. The UE 210 may transmit or otherwise provide (and the network entity 215 may receive or otherwise obtain) a measurement report message carrying or otherwise conveying an indication of a measurement result for the inter-UE CLI measurements. For example, the measurement result may indicate the RSSI for the at least one downlink subband and the RSSI or RSRP for the uplink subband 235. The network entity 215 may use the measurement report for allocation and scheduling decisions relating to communications with the UE 205 and/or with the UE 210. For example, the inter-UE CLI measurement results may be used to mitigate or otherwise manage the inter-UE CLI associated with performing SBFD-based communications during overlapping and/or adjacent SBFD symbol(s). Accordingly, aspects of the techniques described herein provide for the victim UE to be able to perform FDMed simultaneous inter-UE CLI measurements in both the uplink subband 235 and at least one of the downlink subbands.

However, in some situations the victim UE may not be able to support or otherwise perform FDMed simultaneous inter-UE CLI measurements in both subbands. That is, the victim UE may be SFBD aware (e.g., support SBFD-based communications) but may not support FDMed simultaneous CLI measurements in the uplink subband and one or more downlink subbands in the same SBFD symbols(s). In some examples, the capability message may indicate that the UE does not support simultaneous inter-UE CLI measurements. In other examples, the capability message may not include an indication of whether the UE supports simultaneous inter-UE CLI measurements. For a UE that does not support simultaneous (e.g., in overlapping SBFD symbol(s)) inter-UE CLI measurements in both uplink and downlink subbands, this may create an issue when scheduled to perform such measurements.

For example, the victim UE (again the UE 210, in this example) that does not support inter-UE CLI measurements in the uplink and downlink subbands during overlapping SBFD symbol(s) may still receive the measurement resource configuration for performing the inter-UE CLI measurements during the overlapping symbols. Aspects of the techniques described herein provide further mechanisms to address how the victim UE is to respond (e.g., perform or drop) to such measurement resource configuration when the victim UE doesn't support such simultaneous inter-UE CLI measurements.

In one example, the UE may detect or otherwise declare an error state based on the measurement resource configuration being received. That is, a scheduling constraint applied by the network entity 215 may limit or restrict the network entity 215 from configuring the UE with simultaneous inter-UE CLI measurements when the UE does not support such configuration and/or when the network entity 215 is unaware of the UE supporting such measurements. According to the scheduling constraint, the UE may not expect to receive the measurement resource configuration for performing simultaneous inter-UE CLI measurements in the uplink subband 235 and at least one of the downlink subbands during the overlapping SBFD symbol(s). However, the victim UE may still receive such a measurement resource configuration (e.g., due to network error, as part of UE-group scheduling, as part of semi-persistent scheduling, or other conditions). Performing the inter-UE CLI measurements in this situation may include the UE not performing the measurements nor transmitting the measurement report. That is, the error case may include the SBFD aware UE not expecting to receive the measurement resource configuration for FDMed simultaneous CLI measurements in the uplink subband 235 and downlink subband(s) in the same SBFD symbol(s).

In some examples, this may include the victim UE dropping or otherwise disregarding the measurement resource configuration based on the expectation. For example, the UE may disregard, delete, or remove any measurement resource configuration scheduling simultaneous inter-UE CLI measurements in uplink and downlink subbands based on its lack of support for performing such measurements. Accordingly, if an SBFD aware UE receives the measurement resource configuration for the FDMed simultaneous CLI measurements in the uplink subband 235 and at least one downlink subband in the same SBFD symbol(s), the UE may drop the configuration and not perform the CLI measurements.

In other examples, the victim UE receiving the measurement resource configuration scheduling simultaneous inter-UE CLI measurements may perform the measurements and transmit the measurement report message indicating the results. That is, aspects of the techniques described herein provide for the UE that does not support such simultaneous measurements to perform the inter-UE CLI measurements in accordance with the measurement resource configuration. For example, the UE may perform the inter-UE CLI measurements in the uplink subband 235 and/or in the at least one downlink subband. The inter-UE CLI measurements may be performed during the overlapping SBFD symbol(s) according to the uplink timing associated with the uplink subband 235 or according to the downlink timing associated with the at least one downlink subband. The victim UE may transmit the measurement report message to the network entity 215 that carries or otherwise conveys an indication of the measurement result for the inter-UE CLI measurements.

In some examples, the overlapping SBFD symbol(s) may be identified or otherwise determined based on a periodic pattern. That is, the measurement resource configuration may include one or more measurement instances for inter-UE CLI measurements in the uplink subband and also include one or more measurements instances for the inter-UE CLI measurements in the at least one downlink subband. The periodicity (e.g., a first periodicity) of the measurement instances in the uplink subband may be different from the periodicity (e.g., a second periodicity) of the measurement instances in the at least one downlink subband. The first periodicity may be different from the second periodicity such that some measurement instances for the uplink subband overlap (e.g., partially or fully) with measurement instances for the downlink subband while other measurement instances between the subbands may not overlap. In this situation, the victim UE scheduled to perform simultaneous inter-UE CLI measurements may measure the inter-UE CLI in the uplink subband during an uplink subband measurement instance and then measure the inter-UE CLI in the downlink subband during a subband measurement instance. That is, the UE may use the periodicities of the measurement instances within the SBFD slot for each subband to identify which measurement symbol(s) overlap and which measurement symbol(s) do not overlap. The UE may indicate the measurement results based on this scheme in the measurement report message transmitted to the network entity 215.

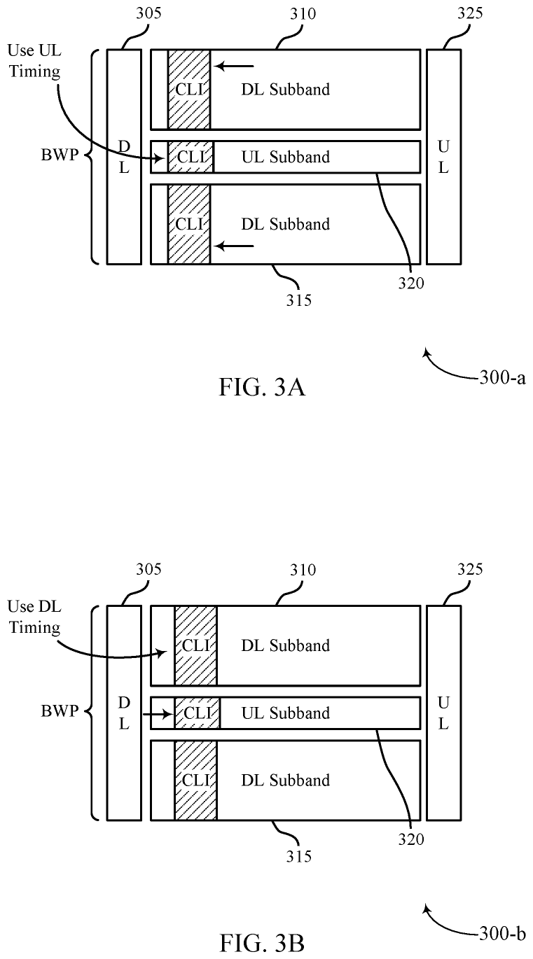

FIGS. 3A and 3B show examples of a SBFD configuration 300 that supports CLI measurement timing for uplink and downlink subbands in accordance with one or more aspects of the present disclosure. SBFD configuration 300 may implement aspects of wireless communications system 100 and/or aspects of wireless communications system 200. Aspects of SBFD configuration 300 may be implemented at or implemented by a UE and/or a network entity, which may be examples of the corresponding devices described herein. SBFD configuration 300-a of FIG. 3A shows an example where the uplink timing of the uplink subband is used for performing simultaneous inter-UE CLI measurements during overlapping SBFD symbol(s). SBFD configuration 300-b of FIG. 3B shows an example where the downlink timing of the downlink subband is used for performing simultaneous inter-UE CLI measurements.

As discussed above, aspects of the techniques described herein provide various techniques for a victim UE to measure the inter-UE CLI for an aggressor UE when operating using SBFD based communications. For example, the SBFD communications may include a bandwidth (e.g., such as a downlink BWP) being divided into uplink and downlink subbands. For example, during the initial symbol(s) of the SBFD slot, the full BWP may be allocated to downlink communications 305, which may be used to carry downlink control messages, such as grants. The final symbol(s) of the SBFD slot the full BWP may be allocated to uplink communications 325, such as uplink control messages. The remaining symbols of the SBFD slot may include the BWP being divided into at least one uplink subband (e.g., uplink subband 320) and at least one downlink subband. In the non-limiting example illustrated in FIG. 3, the BWP may divided into two downlink subbands (e.g., downlink subband 310 and downlink subband 315). However, it is to be understood that the BWP may be divided into different numbers of uplink and downlink subbands.

The victim UE may receive or otherwise obtain a measurement resource configuration that configures the UE to perform inter-UE CLI measurements during overlapping SBFD symbol(s) in the uplink subband 320 and in at least one downlink subband (e.g., downlink subband 310 and/or downlink subband 315). However, the uplink subband 320 may be associated with an uplink timing that is different from the downlink timing that is associated with the at least one downlink subband. Moreover, the UE may not, in some examples, support simultaneous inter-UE CLI measurements in the uplink and downlink subbands. Accordingly, aspects of the techniques described herein provide various mechanisms for the UE to perform the inter-UE CLI measurements in the uplink and/or in the downlink subband(s) during the overlapping SBFD symbol(s) based on the uplink timing or based on the downlink timing.

Turning to SBFD configuration 300-a of FIG. 3A first, this may include the UE using the uplink timing associated with the uplink subband 320 to perform the inter-UE CLI measurements in the uplink subband 320 and in the at least one downlink subband during the overlapping SBFD symbol(s). For example, the uplink timing advance for the uplink subband 320 may be shorter than the downlink timing advance for the at least one downlink subband. This may generally mean that uplink transmissions according to the uplink timing begin before downlink transmissions according to the downlink timing. In this situation, the UE may shift, move, or otherwise switch from the downlink timing to the uplink timing to perform the simultaneous inter-UE CLI measurements in both the uplink subband 320 and in the at least one downlink subband.

In some examples, this may be based on a timing rule associated with the network entity and/or with the UE. For example, a timing rule may be configured or otherwise established such that the UE and the network entity know that, when configured for simultaneous inter-UE CLI measurements in uplink and downlink subbands, the UE is to apply or otherwise switch from the downlink timing to the uplink timing to perform the CLI measurements in both the uplink subband 320 and in the at least one downlink subband. The timing rule may be configured by the network entity for the UE, such as using RRC signaling, medium access control-control element (MAC-CE) signaling, or other signaling. In some examples, the timing rule may be defined or otherwise signaled in the measurement resource configuration that configures the simultaneous inter-UE CLI measurements. In some examples, the timing rule may be (pre) configured or otherwise established within the wireless network such that the UE and/or the network entity may be aware of which timing rule is to be applied.

Accordingly, the UE may use the uplink timing to measure or otherwise perform the inter-UE CLI measurements in the uplink subband 320 and in the at least one downlink subband during the overlapping SBFD symbol(s) according to the measurement resource configuration. For example, the UE may use the uplink timing to measure the RSSI of the at least one downlink subband and to measure the RSSI and/or RSRP in the uplink subband 320.

Accordingly, SBFD configuration 300-a illustrates a non-limiting example of where a SBFD aware UE that does not support FDMed simultaneous CLI measurement in the uplink subband and in the downlink subband(s) in the same SBFD symbol(s), the same timing may be used for the CLI measurement in uplink subband and downlink subband(s). In this example, the FDMed simultaneous CLI measurement in uplink subband and downlink subband(s) may both be based on the timing. This may include a new rule being established (e.g., the timing rule) where UE autonomously assumes the uplink timing for CLI measurements if the UE receives the measurement resource configuration for the FDMed simultaneous CLI measurement in the uplink subband and the downlink subband(s) in the same SBFD symbol(s). As discussed, then one or two gap symbols may be allocated before the CLI measurement symbol(s) to support switching the downlink timing for the downlink subband(s) reception to the uplink timing. In some aspects, a single FFT window (e.g., measurement window) may be used for the simultaneous inter-UE CLI measurements.

In this example, the victim UE may measure the RSSI within the downlink subband using uplink timing, measure the RSRP of the aggressor UE within the uplink subband using the uplink timing, and/or measure the RSSI within uplink subband using the uplink timing.

Turning to SBFD configuration 300-b of FIG. 3B, this may include the UE using the downlink timing associated with the at least one downlink subband to perform the inter-UE CLI measurements in the uplink subband 320 and in the at least one downlink subband during the overlapping SBFD symbol(s). For example, the downlink timing advance for the downlink subband may be longer than the uplink timing advance for the uplink subband. This may generally mean that uplink transmissions according to the uplink timing begin before downlink transmissions according to the downlink timing. In this situation, the UE may shift, move, or otherwise switch from the uplink timing to the downlink timing to perform the simultaneous inter-UE CLI measurements in both the uplink subband 320 and in the at least one downlink subband.

In some examples, this may be based on the timing rule associated with the network entity and/or with the UE. For example, a timing rule may be configured or otherwise established such that the UE and the network entity know that, when configured for simultaneous inter-UE CLI measurements in uplink and downlink subbands, the UE is to apply or otherwise switch from the uplink timing to the downlink timing to perform the CLI measurements in both the uplink subband 320 and in the at least one downlink subband.

In some examples, a set of trailing gap symbols may be configured for the UE to switch from the uplink timing to the downlink timing to perform the inter-UE CLI measurements in the uplink subband 320 and in the at least one downlink subband during the overlapping SBFD symbol(s).

Accordingly, the UE may use the downlink timing to measure or otherwise perform the inter-UE CLI measurements in the uplink subband 320 and in the at least one downlink subband during the overlapping SBFD symbol(s) according to the measurement resource configuration. For example, the UE may use the downlink timing to measure the RSSI of the at least one downlink subband and to measure the RSSI in the uplink subband 320.

Accordingly, SBFD configuration 300-b illustrates a non-limiting example of where a SBFD aware UE that does not support FDMed simultaneous CLI measurement in the uplink subband and in the downlink subband(s) in the same SBFD symbol(s), the SBFD aware UE that does not support FDMed simultaneous CLI measurement in the uplink subband 320 and in the at least one downlink subband(s) in the same SBFD symbol(s), the same timing may be used for the CLI measurements in the uplink subband and in the downlink subband(s). This timing rule may indicate that for the FDMed simultaneous CLI measurements in the uplink subband and in the downlink subband(s) may both be based on the downlink timing. That is, in this example the timing rule may indicate that the UE autonomously assumes the downlink timing for CLI measurement if the UE receives the measurement resource configuration of FDMed simultaneous CLI measurement in the uplink subband and in the at least downlink subband(s) in the same SBFD symbol(s). As discussed, the set of trailing gap symbol(s) (e.g., one or two gap symbols, depending on the SCS) after CLI measurement symbol(s) may be configured or otherwise allocated to enable the UE to switch from the downlink timing for the uplink subband back to uplink timing.

In some aspects, the scheduling restriction of one or two gap symbols before the CLI measurement symbol(s) (e.g., the set of preceding gap symbols) may be relaxed or otherwise removed since downlink timing is used for the inter-UE CLI measurements. In some aspects, the single FFT window (e.g., measurement occasion or window) may be used for the reference signal reception and/or CLI measurements. In this example, the UE may measures the RSSI within the at least one downlink subband using the downlink timing and measure the RSSI within uplink subband using the downlink timing.

In some examples, the network entity may instruct the UE which timing to use when performing the inter-UE CLI measurements in the uplink subband and in the at least one downlink subband. For example, the network entity may transmit or otherwise provide (and the UE may receive or otherwise obtain) an indication to use the uplink timing when performing inter-UE CLI measurements in the uplink subband and in the at least one downlink subband (e.g., per SBFD configuration 300-a) or to use the downlink timing when performing the inter-UE CLI measurements in the at least one downlink subband (e.g., per SBFD configuration 300-b). The indication may be provided, at least to some degree, based on the UE not supporting simultaneous inter-UE CLI measurements in both the uplink subband and in the at least one downlink subband during the overlapping symbols. Accordingly, this feature may enable to the network entity to indicate to the SBFD aware UE that it is to measure the uplink/downlink subband inter-UE CLI using the uplink timing or the downlink timing.

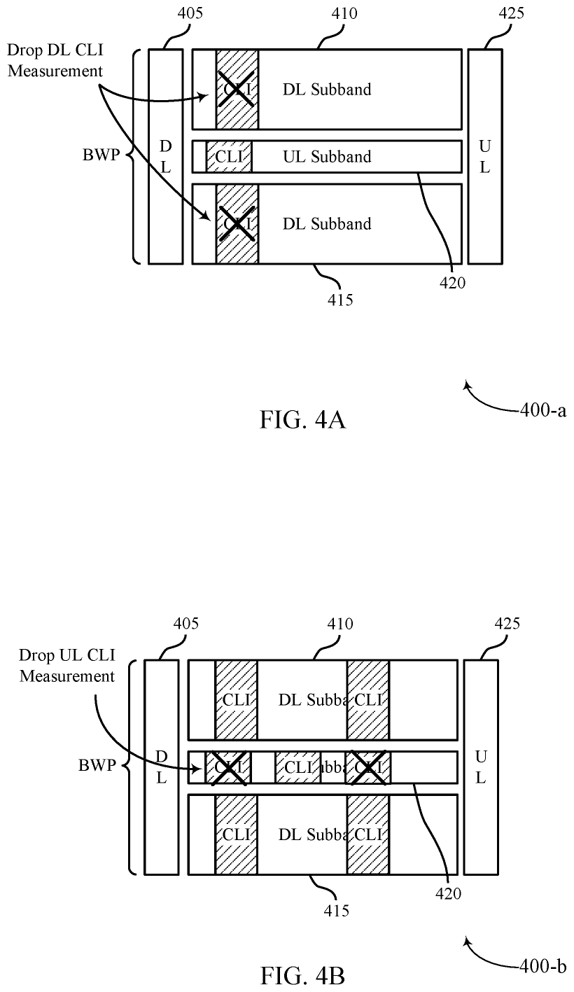

FIGS. 4A and 4B show examples of a SBFD configuration 400 that supports CLI measurement timing for uplink and downlink subbands in accordance with one or more aspects of the present disclosure. SBFD configuration 400 may implement aspects of wireless communications system 100, aspects of wireless communications system 200, and/or aspects of SBFD configuration 300. Aspects of SBFD configuration 400 may be implemented at or implemented by a UE and/or a network entity, which may be examples of the corresponding devices described herein. SBFD configuration 400-a of FIG. 4A shows an example where the inter-UE CLI measurements in the downlink subbands are dropped when scheduled to perform simultaneous inter-UE CLI measurements during overlapping SBFD symbol(s). SBFD configuration 400-b of FIG. 4B shows an example where the inter-UE CLI measurements in the uplink subband are dropped when scheduled to perform simultaneous inter-UE CLI measurements.

As discussed above, aspects of the techniques described herein provide various techniques for a victim UE to measure the inter-UE CLI for an aggressor UE when operating using SBFD based communications. For example, the SBFD communications may include a bandwidth (e.g., such as a downlink BWP) being divided into uplink and downlink subbands. For example, during the initial symbol(s) of the SBFD slot, the full BWP may be allocated to downlink communications 405, which may be used to carry downlink control messages, such as grants. The final symbol(s) of the SBFD slot the full BWP may be allocated to uplink communications 425, such as uplink control messages. The remaining symbols of the SBFD slot may include the BWP being divided into at least one uplink subband (e.g., uplink subband 420) and at least one downlink subband. In the non-limiting example illustrated in FIG. 4, the BWP may divided into two downlink subbands (e.g., downlink subband 410 and downlink subband 415). However, it is to be understood that the BWP may be divided into different numbers of uplink and downlink subbands.

The victim UE may receive or otherwise obtain a measurement resource configuration that configures the UE to perform inter-UE CLI measurements during overlapping SBFD symbol(s) in the uplink subband 420 and in at least one downlink subband (e.g., downlink subband 410 and/or downlink subband 415). However, the uplink subband 420 may be associated with an uplink timing that is different from the downlink timing that is associated with the at least one downlink subband. Moreover, the UE may not, in some examples, support simultaneous inter-UE CLI measurements in the uplink and downlink subbands. Accordingly, aspects of the techniques described herein provide various mechanisms for the UE to perform the inter-UE CLI measurements in the uplink and/or in the downlink subband(s) during the overlapping SBFD symbol(s) based on the uplink timing or based on the downlink timing.

Turning to SBFD configuration 400-a of FIG. 4A first, this may include the UE dropping the inter-UE CLI measurements in the at least one downlink subband (e.g., the UE may not perform the inter-UE CLI measurements in the at least downlink subband). Instead, the UE may perform the inter-UE CLI measurements in the uplink subband according to the uplink timing. For example, the UE may use the uplink timing to measure or otherwise determine the RSRP and/or the RSSI of the uplink subband 420 during the overlapping SBFD symbol(s) and skip, drop, or otherwise not perform the RSSI of the at least one downlink subband.

Accordingly, SBFD configuration 400-a illustrates a non-limiting example where a SBFD aware UE that does not support FDMed simultaneous CLI measurement in the uplink subband and in the at lest one downlink subband(s) in the same SBFD symbol(s), the same timing may be used for performing the CLI measurements in the uplink subband and the at least one downlink subband(s). In this example, the UE maintains the inter-UE CLI measurement in the uplink subband and drops the inter-UE CLI measurement in the downlink subband(s).

In some examples, this may be based on a rule, such as the timing rule or a different rule (e.g., a dropping rule) that is known by the network entity and the UE. The rule may indicate or otherwise identify which inter-UE CLI measurements are performed and/or which inter-UE CLI measurements are dropped. The rule may be signaled, such as using RRC signaling, MAC-CE signaling, and/or signaled in the measurement resource configuration. The rule may be (pre) configured within the wireless network, in some example. Broadly, the new rule may include the UE autonomously dropping the CLI measurements in the downlink subband(s) if the UE receives the measurement resource configuration for FDMed simultaneous CLI measurement in the uplink subband and the downlink subband(s) in the same SBFD symbol(s). In this example of the rule where the downlink subband CLI measurements are dropped, the uplink timing will be used for performing the inter-UE CLI measurements in the uplink subband. In some examples, a single FFT window (e.g., measurement window) may be allocated or otherwise configured for the reception/measurement of the CLI. In this example, the UE may measure or otherwise determine the RSRP of the aggressor UE within uplink subband using uplink timing and/or may measure the RSSI within the uplink subband using the uplink timing.

Turning next to SBFD configuration 400-b of FIG. 4B, this may include the UE dropping the inter-UE CLI measurements in the uplink subband (e.g., the UE may not perform the inter-UE CLI measurements in the uplink subband). Instead, the UE may perform the inter-UE CLI measurements in the at least one downlink subband according to the downlink timing. For example, the UE may use the downlink timing to measure or otherwise determine the RSSI of the downlink subband(s) during the overlapping SBFD symbol(s) and skip, drop, or otherwise not perform the RSSI and/or RSRP measurement within the uplink subband.

Accordingly, SBFD configuration 400-b illustrates a non-limiting example where a SBFD aware UE that does not support FDMed simultaneous CLI measurements in the uplink subband and the downlink subband(s) in the same SBFD symbol(s) where the same timing may be used for the CLI measurements. This may include maintaining the inter-UE CLI measurement in the downlink subband(s) and dropping, skipping, or otherwise not performing the CLI measurement in the uplink subband.

Again, this may be based on a new rule (e.g., timing rule or dropping rule) where the UE autonomously drops the CLI measurement in the uplink subband if the UE receives the measurement resource configuration of FDMed simultaneous CLI measurements in the uplink subband and in the downlink subband(s) in the same SBFD symbol(s). In this situation, the downlink timing may be used to perform the inter-UE CLI measurements in the downlink subband(s). Again, in some examples a single FFT window (e.g., measurement window) may be scheduled or otherwise used for the reception and/or measurements associated with the inter-UE CLI measurements. One non-limiting example of application of this rule may include the use case where the timing is off between downlink and uplink subbands (e.g., the downlink timing is different from the uplink timing). In this case, the UE may measure the RSSI in the downlink subband. That is, the UE may measure the RSSI within the at least one downlink subband using the downlink timing.

In some examples, the network entity may instruct the UE which CLI measurement to drop and/or to perform. For example, the network entity may transmit or otherwise provide (and the UE may receive or otherwise obtain) an indication to drop the inter-UE CLI measurements in the uplink subband (e.g., per SBFD configuration 400-a) or in the at least one downlink subband (e.g., per SBFD configuration 400-b). The indication may be provided, at least to some degree, on the UE not supporting simultaneous inter-UE CLI measurements in both the uplink subband and in the at least one downlink subband during the overlapping symbols. Accordingly, this feature may enable to the network entity to indicate to the SBFD aware UE that it is to measure the uplink/downlink subband inter-UE CLI and drop the downlink/uplink subband inter-UE CLI measurement.

SBFD configuration 400-b also illustrates an example of the periodicity of the measurement occasions or instances in the uplink subband and in the downlink subband(s) being used to identify or otherwise determine the overlapping SBFD symbol(s). As shown, the first periodicity of CLI measurements in the uplink subband may be different from the second periodicity of the CLI measurements in the downlink subband. This may result in some uplink subband measurement instances overlapping (e.g., in the time domain) with one or more downlink subband measurement instances (with two overlapping instances being shown by way of example only). In this example, the UE may drop the first and third uplink subband CLI measurement instances and, instead, measure the CLI in the downlink subband(s) using the downlink timing. The UE may measure the inter-UE CLI in the uplink subband using the uplink timing during the uplink subband measurement instance that does not overlap in the time domain with a downlink subband measurement instance (with one non-overlapping uplink subband measurement instance being shown by way of example only). The UE may use the periodicities of the measurement instances in the uplink and downlink subbands to identify or otherwise determine the overlapping SBFD symbol(s).

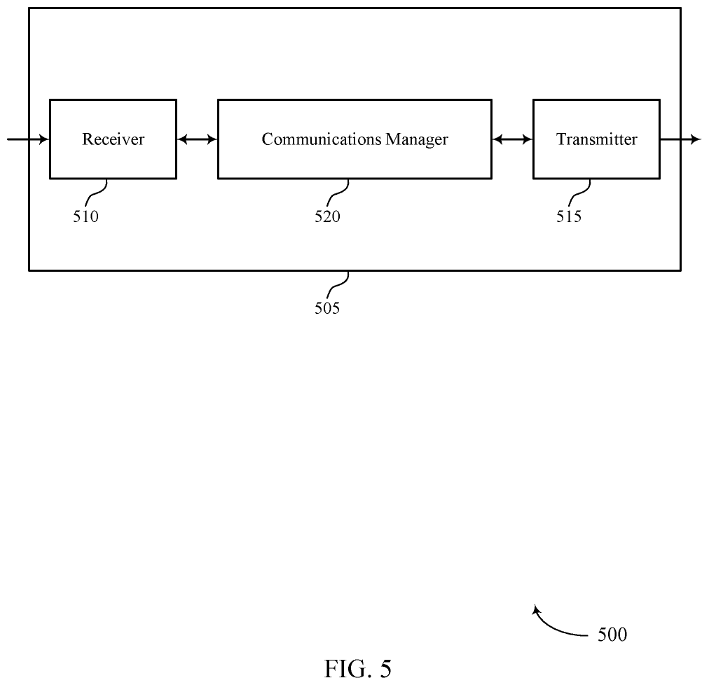

FIG. 5 shows a block diagram 500 of a device 505 that supports CLI measurement timing for uplink and downlink subbands in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to CLI measurement timing for uplink and downlink subbands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CLI measurement timing for uplink and downlink subbands). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of CLI measurement timing for uplink and downlink subbands as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a capability message indicating that the UE supports performing inter-UE CLI measurements in an uplink subband and in at least one downlink subband during one or more overlapping SBFD symbols. The communications manager 520 is capable of, configured to, or operable to support a means for receiving, based on the capability message, a measurement resource configuration for performing the inter-UE CLI measurements in the uplink subband and the at least one downlink subband. The communications manager 520 is capable of, configured to, or operable to support a means for transmitting, according to the measurement resource configuration, a measurement report message indicating a measurement result for the inter-UE CLI measurements.

Additionally, or alternatively, the communications manager 520 may support wireless communications in accordance with examples as disclosed herein. For example, the communications manager 520 is capable of, configured to, or operable to support a means for receiving measurement resource configuration for performing inter-UE CLI measurements during one or more overlapping SBFD symbols and in an uplink subband associated with an uplink timing and in at least one downlink subband associated with a downlink timing that is different from the uplink timing. The communications manager 520 is capable of, configured to, or operable to support a means for performing, in accordance with the measurement resource configuration, the inter-UE CLI measurements in the uplink subband, in the at least one downlink subband, or both, according to the uplink timing or to the downlink timing to obtain a measurement result. The communications manager 520 is capable of, configured to, or operable to support a means for transmitting a measurement report message indicating the measurement result for the inter-UE CLI measurements.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for enabling and/or otherwise supporting simultaneous inter-UE CLI measurements in the uplink subband and in at least one downlink subband. This may enable a SBFD aware UE receiving a measurement resource configuration to for such simultaneous measurements to perform, at least to some degree, the CLI measurements and report the measurement results.

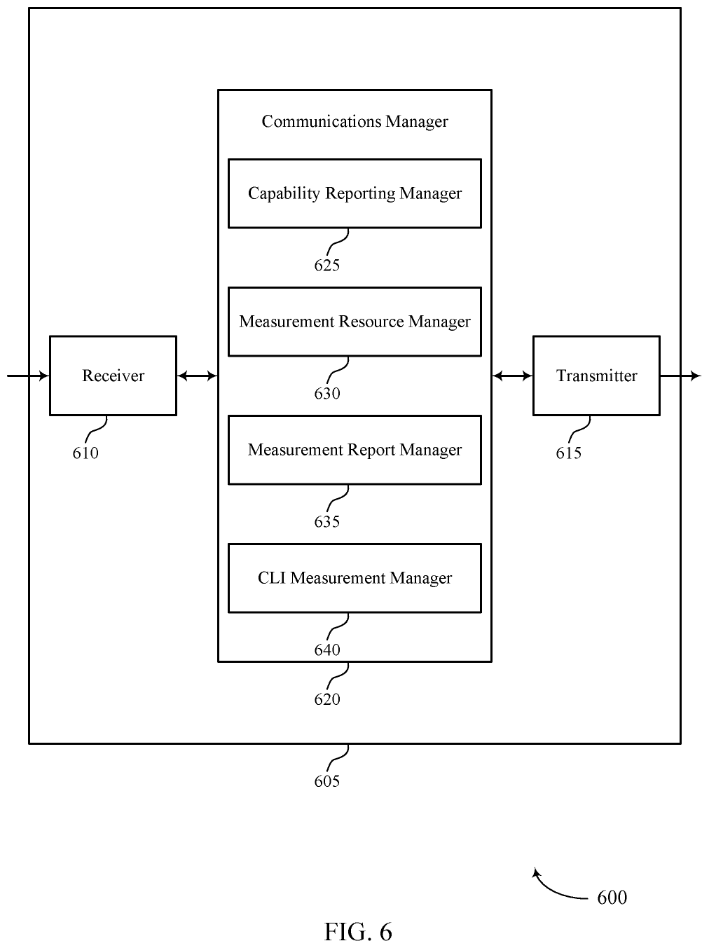

FIG. 6 shows a block diagram 600 of a device 605 that supports CLI measurement timing for uplink and downlink subbands in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to CLI measurement timing for uplink and downlink subbands). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CLI measurement timing for uplink and downlink subbands). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of CLI measurement timing for uplink and downlink subbands as described herein. For example, the communications manager 620 may include a capability reporting manager 625, a measurement resource manager 630, a measurement report manager 635, a CLI measurement manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability reporting manager 625 is capable of, configured to, or operable to support a means for transmitting a capability message indicating that the UE supports performing inter-UE CLI measurements in an uplink subband and in at least one downlink subband during one or more overlapping SBFD symbols. The measurement resource manager 630 is capable of, configured to, or operable to support a means for receiving, based on the capability message, a measurement resource configuration for performing the inter-UE CLI measurements in the uplink subband and the at least one downlink subband. The measurement report manager 635 is capable of, configured to, or operable to support a means for transmitting, according to the measurement resource configuration, a measurement report message indicating a measurement result for the inter-UE CLI measurements.

Additionally, or alternatively, the communications manager 620 may support wireless communications in accordance with examples as disclosed herein. The measurement resource manager 630 is capable of, configured to, or operable to support a means for receiving measurement resource configuration for performing inter-UE CLI measurements during one or more overlapping SBFD symbols and in an uplink subband associated with an uplink timing and in at least one downlink subband associated with a downlink timing that is different from the uplink timing. The CLI measurement manager 640 is capable of, configured to, or operable to support a means for performing, in accordance with the measurement resource configuration, the inter-UE CLI measurements in the uplink subband, in the at least one downlink subband, or both, according to the uplink timing or to the downlink timing to obtain a measurement result. The measurement report manager 635 is capable of, configured to, or operable to support a means for transmitting a measurement report message indicating the measurement result for the inter-UE CLI measurements.

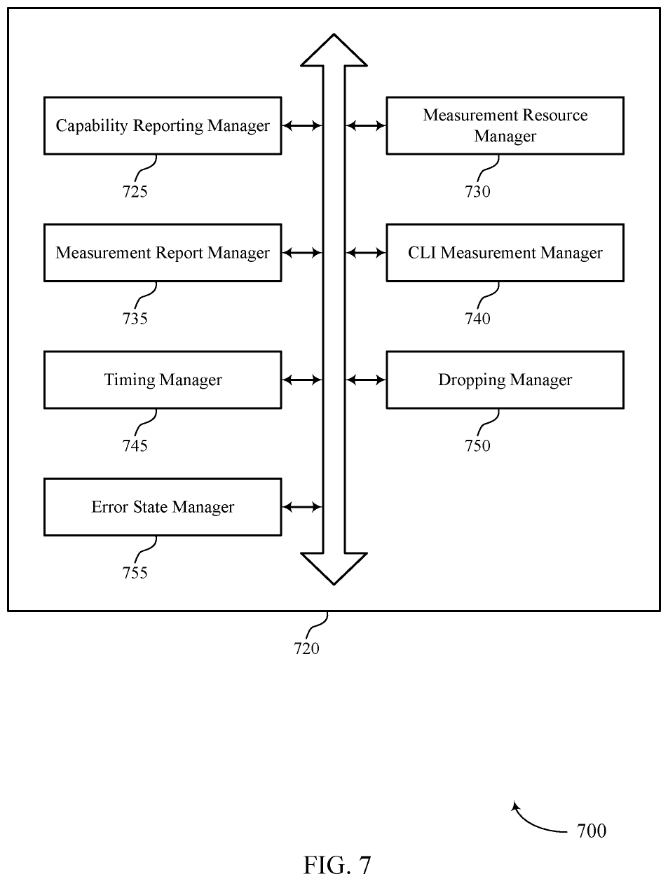

FIG. 7 shows a block diagram 700 of a communications manager 720 that supports CLI measurement timing for uplink and downlink subbands in accordance with one or more aspects of the present disclosure. The communications manager 720 may be an example of aspects of a communications manager 520, a communications manager 620, or both, as described herein. The communications manager 720, or various components thereof, may be an example of means for performing various aspects of CLI measurement timing for uplink and downlink subbands as described herein. For example, the communications manager 720 may include a capability reporting manager 725, a measurement resource manager 730, a measurement report manager 735, a CLI measurement manager 740, a timing manager 745, a dropping manager 750, an error state manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability reporting manager 725 is capable of, configured to, or operable to support a means for transmitting a capability message indicating that the UE supports performing inter-UE CLI measurements in an uplink subband and in at least one downlink subband during one or more overlapping SBFD symbols. The measurement resource manager 730 is capable of, configured to, or operable to support a means for receiving, based on the capability message, a measurement resource configuration for performing the inter-UE CLI measurements in the uplink subband and the at least one downlink subband. The measurement report manager 735 is capable of, configured to, or operable to support a means for transmitting, according to the measurement resource configuration, a measurement report message indicating a measurement result for the inter-UE CLI measurements.

In some examples, the CLI measurement manager 740 is capable of, configured to, or operable to support a means for performing the inter-UE CLI measurements in the uplink subband and in the at least one downlink subband during the one or more overlapping SBFD symbols to obtain the measurement result. In some examples, performing the inter-UE CLI measurements in the uplink subband is in accordance with an uplink timing associated with the uplink subband and performing the inter-UE CLI measurements in the at least one downlink subband is in accordance with a downlink timing associated with the at least one downlink subband, the uplink timing being different from the downlink timing. In some examples, performing the inter-UE CLI measurements in the uplink subband and in the at least one downlink subband is in accordance with one or more measurement windows associated with the uplink subband and the at least one downlink subband. In some examples, the one or more overlapping SBFD symbols are associated with SBFD communications using the uplink subband and the at least one downlink subband.

Additionally, or alternatively, the communications manager 720 may support wireless communications in accordance with examples as disclosed herein. In some examples, the measurement resource manager 730 is capable of, configured to, or operable to support a means for receiving measurement resource configuration for performing inter-UE CLI measurements during one or more overlapping SBFD symbols and in an uplink subband associated with an uplink timing and in at least one downlink subband associated with a downlink timing that is different from the uplink timing. The CLI measurement manager 740 is capable of, configured to, or operable to support a means for performing, in accordance with the measurement resource configuration, the inter-UE CLI measurements in the uplink subband, in the at least one downlink subband, or both, according to the uplink timing or to the downlink timing to obtain a measurement result. In some examples, the measurement report manager 735 is capable of, configured to, or operable to support a means for transmitting a measurement report message indicating the measurement result for the inter-UE CLI measurements.

In some examples, to support performing the inter-UE CLI measurements, the timing manager 745 is capable of, configured to, or operable to support a means for performing the inter-UE CLI measurements in the uplink subband and in the at least one downlink subband according to the uplink timing. In some examples, the timing manager 745 is capable of, configured to, or operable to support a means for switching, during a set of preceding gap symbols, from the downlink timing to the uplink timing to perform the inter-UE CLI measurements in the uplink subband and in the at least one downlink subband.

In some examples, to support performing the inter-UE CLI measurements, the timing manager 745 is capable of, configured to, or operable to support a means for measuring, using the uplink timing, a first RSSI in the at least one downlink subband, a RSRP in the uplink subband, a second RSSI in the uplink subband, or a combination thereof. In some examples, the timing manager 745 is capable of, configured to, or operable to support a means for performing the inter-UE CLI measurements according to the uplink timing is based on a timing rule associated with the UE. In some examples, a set of preceding gap symbols are removed in accordance with performing the inter-UE CLI measurements according to the downlink timing.

In some examples, to support performing the inter-UE CLI measurements, the timing manager 745 is capable of, configured to, or operable to support a means for performing the inter-UE CLI measurements in the uplink subband and in the at least one downlink subband according to the downlink timing. In some examples, the timing manager 745 is capable of, configured to, or operable to support a means for switching, during a set of trailing gap symbols, from the uplink timing to the downlink timing to perform the inter-UE CLI measurements in the uplink subband and in the at least one downlink subband. In some examples, to support performing the inter-UE CLI measurements, the timing manager 745 is capable of, configured to, or operable to support a means for measuring, using the downlink timing, a first RSSI in the at least one downlink subband, a second RSSI in the uplink subband, or a combination thereof. In some examples, to support performing the inter-UE CLI measurements, the timing manager 745 is capable of, configured to, or operable to support a means for performing the inter-UE CLI measurements according to the downlink timing is based on a timing rule associated with the UE.

In some examples, to support performing the inter-UE CLI measurements, the dropping manager 750 is capable of, configured to, or operable to support a means for dropping the inter-UE CLI measurements in the at least one downlink subband in accordance with the downlink timing being different from the uplink timing. In some examples, to support performing the inter-UE CLI measurements, the dropping manager 750 is capable of, configured to, or operable to support a means for performing the inter-UE CLI measurements in the uplink subband according to the uplink timing. In some examples, to support performing the inter-UE CLI measurements, the dropping manager 750 is capable of, configured to, or operable to support a means for dropping the inter-UE CLI measurements in the at least one downlink subband is based on a dropping rule associated with the UE.

In some examples, to support performing the inter-UE CLI measurements, the dropping manager 750 is capable of, configured to, or operable to support a means for measuring, using the uplink timing and in accordance with the dropping, a RSRP in the uplink subband, a RSSI in the uplink subband, or a combination thereof.

In some examples, to support performing the inter-UE CLI measurements, the dropping manager 750 is capable of, configured to, or operable to support a means for dropping the inter-UE CLI measurements in the uplink subband in accordance with the downlink timing being different from the uplink timing. In some examples, to support performing the inter-UE CLI measurements, the dropping manager 750 is capable of, configured to, or operable to support a means for performing the inter-UE CLI measurements in the at least one downlink subband according to the downlink timing. In some examples, to support performing the inter-UE CLI measurements, the dropping manager 750 is capable of, configured to, or operable to support a means for measuring, using the downlink timing and in accordance with the dropping, a RSSI in the at least one downlink subband. In some examples, to support performing the inter-UE CLI measurements, the dropping manager 750 is capable of, configured to, or operable to support a means for dropping the inter-UE CLI measurements in the uplink subband is based on a dropping rule associated with the UE.

In some examples, to support performing the inter-UE CLI measurements, the error state manager 755 is capable of, configured to, or operable to support a means for detecting an error state in accordance with the measurement resource configuration being received for inter-UE CLI measurements in the uplink subband and the at least one downlink subband during the one or more overlapping SBFD symbols, the error state corresponding to an expectation that the UE is not to receive the measurement resource configuration for performing simultaneous inter-UE CLI measurements in the uplink subband and in the at least one downlink subband during the one or more overlapping SBFD symbols, where performing the inter-UE CLI measurements and transmitting the measurement report message are in accordance with the error state.

In some examples, to support performing the inter-UE CLI measurements, the error state manager 755 is capable of, configured to, or operable to support a means for dropping the measurement resource configuration in accordance with an expectation that the UE is not to receive CLI measurements in the uplink subband and in the at least one downlink subband during the one or more overlapping SBFD symbols, where performing the inter-UE CLI measurements and transmitting the measurement report message are in accordance with the dropping.

In some examples, to support performing the inter-UE CLI measurements, the dropping manager 750 is capable of, configured to, or operable to support a means for receiving an indication to drop the inter-UE CLI measurements in the uplink subband or in the at least one downlink subband, the indication in accordance with the UE not supporting simultaneous CLI measurements in the uplink subband and in the at least one downlink subband during the one or more overlapping SBFD symbols.

In some examples, to support performing the inter-UE CLI measurements, the timing manager 745 is capable of, configured to, or operable to support a means for receiving an indication to use the uplink timing or the downlink timing for the inter-UE CLI measurements in the uplink subband, in the at least one downlink subband, or both, the indication in accordance with the UE not supporting simultaneous inter-UE CLI measurements in the uplink subband and in the at least one downlink subband during the one or more overlapping SBFD symbols.

In some examples, the timing manager 745 is capable of, configured to, or operable to support a means for identifying an overlap between one or more uplink subband measurement instances and one or more downlink subband measurement instances according to the measurement resource configuration, where performing the inter-UE CLI measurements in the uplink subband, in the at least one downlink subband, or both, is in accordance with the overlap.

In some examples, the timing manager 745 is capable of, configured to, or operable to support a means for identifying a first periodicity for the inter-UE CLI measurements in the uplink subband and a second periodicity for the inter-UE CLI measurements in the at least one downlink subband, where the overlap is in accordance with the first periodicity and the second periodicity.

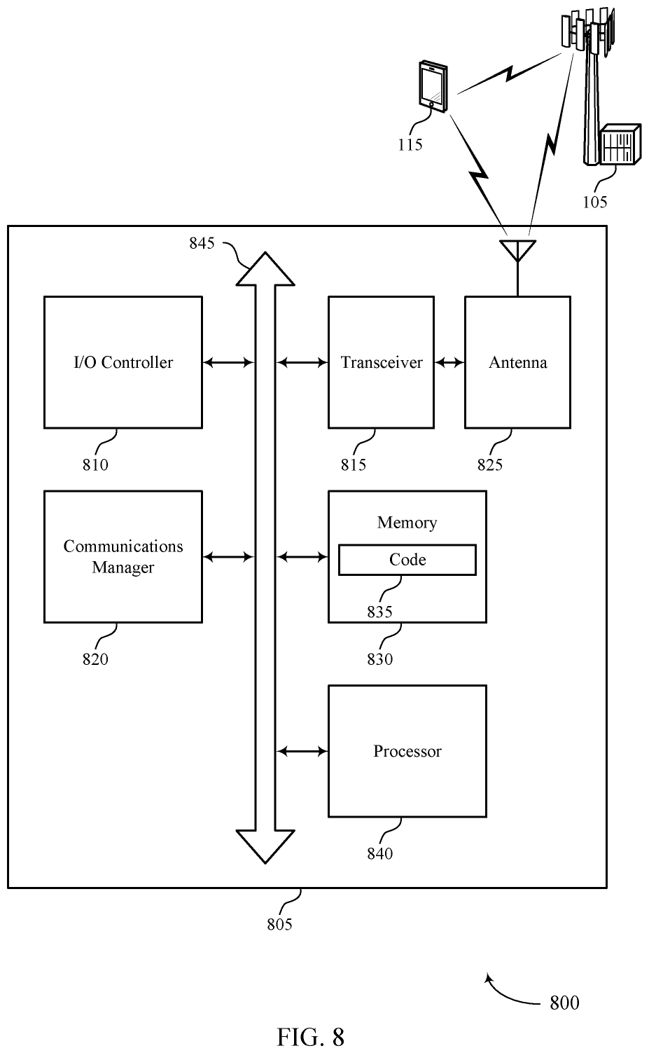

FIG. 8 shows a diagram of a system 800 including a device 805 that supports CLI measurement timing for uplink and downlink subbands in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting CLI measurement timing for uplink and downlink subbands). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a capability message indicating that the UE supports performing inter-UE CLI measurements in an uplink subband and in at least one downlink subband during one or more overlapping SBFD symbols. The communications manager 820 is capable of, configured to, or operable to support a means for receiving, based on the capability message, a measurement resource configuration for performing the inter-UE CLI measurements in the uplink subband and the at least one downlink subband. The communications manager 820 is capable of, configured to, or operable to support a means for transmitting, according to the measurement resource configuration, a measurement report message indicating a measurement result for the inter-UE CLI measurements.

Additionally, or alternatively, the communications manager 820 may support wireless communications in accordance with examples as disclosed herein. For example, the communications manager 820 is capable of, configured to, or operable to support a means for receiving measurement resource configuration for performing inter-UE CLI measurements during one or more overlapping SBFD symbols and in an uplink subband associated with an uplink timing and in at least one downlink subband associated with a downlink timing that is different from the uplink timing. The communications manager 820 is capable of, configured to, or operable to support a means for performing, in accordance with the measurement resource configuration, the inter-UE CLI measurements in the uplink subband, in the at least one downlink subband, or both, according to the uplink timing or to the downlink timing to obtain a measurement result. The communications manager 820 is capable of, configured to, or operable to support a means for transmitting a measurement report message indicating the measurement result for the inter-UE CLI measurements.

By including or configuring the communications manager 820 in accordance with examples as described herein, the device 805 may support techniques for enabling and/or otherwise supporting simultaneous inter-UE CLI measurements in the uplink subband and in at least one downlink subband. This may enable a SBFD aware UE receiving a measurement resource configuration to for such simultaneous measurements to perform, at least to some degree, the CLI measurements and report the measurement results.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of CLI measurement timing for uplink and downlink subbands as described herein, or the at least one processor 840 and the at least one memory 830 may be otherwise configured to, individually or collectively, perform or support such operations.

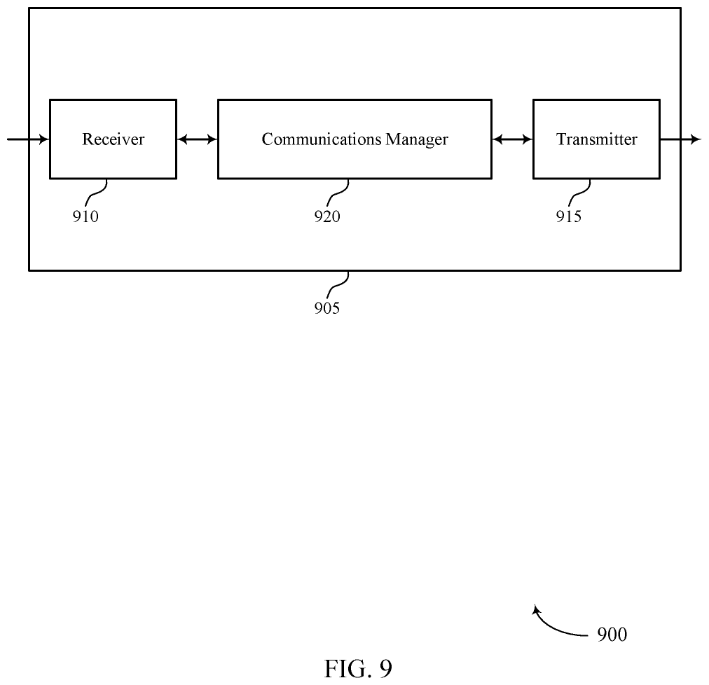

FIG. 9 shows a block diagram 900 of a device 905 that supports CLI measurement timing for uplink and downlink subbands in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of CLI measurement timing for uplink and downlink subbands as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a UE, a capability message indicating that the UE supports performing inter-UE CLI measurements in an uplink subband and in at least one downlink subband during one or more overlapping SBFD symbols. The communications manager 920 is capable of, configured to, or operable to support a means for transmitting, based on the capability message, a measurement resource configuration for the UE to perform the inter-UE CLI measurements in the uplink subband and in the at least one downlink subband. The communications manager 920 is capable of, configured to, or operable to support a means for receiving, according to the measurement resource configuration, a measurement report message indicating a measurement result for the inter-UE CLI measurements.

Additionally, or alternatively, the communications manager 920 may support wireless communications in accordance with examples as disclosed herein. For example, the communications manager 920 is capable of, configured to, or operable to support a means for transmitting, to a UE, a measurement resource configuration for the UE to perform inter-UE CLI measurements during one or more overlapping SBFD symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing. The communications manager 920 is capable of, configured to, or operable to support a means for receiving a measurement report message indicating a measurement result for the inter-UE CLI measurements.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for enabling and/or otherwise supporting simultaneous inter-UE CLI measurements in the uplink subband and in at least one downlink subband. This may enable a SBFD aware UE receiving a measurement resource configuration to for such simultaneous measurements to perform, at least to some degree, the CLI measurements and report the measurement results.

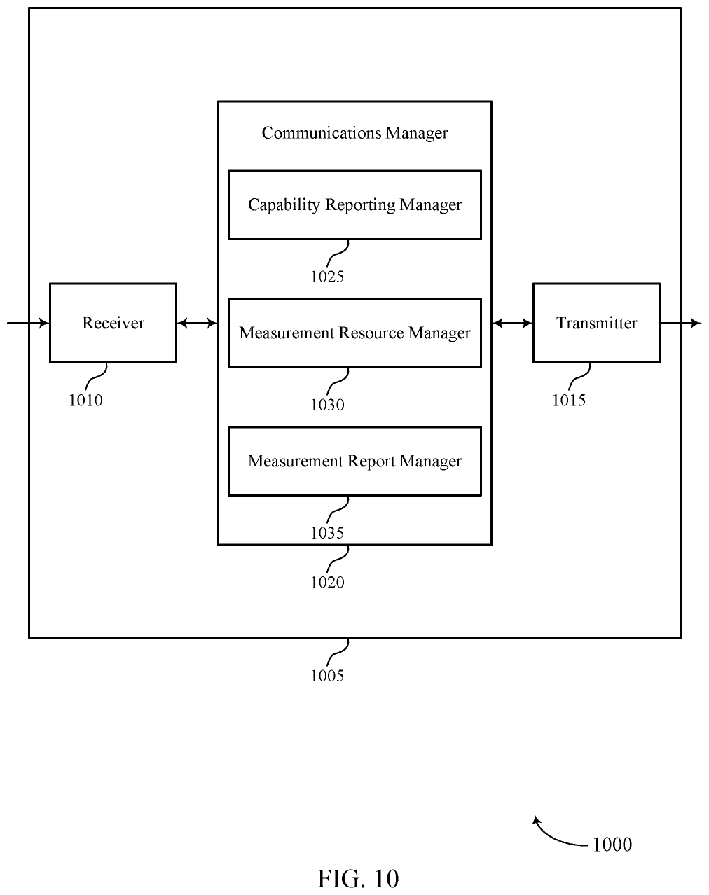

FIG. 10 shows a block diagram 1000 of a device 1005 that supports CLI measurement timing for uplink and downlink subbands in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of CLI measurement timing for uplink and downlink subbands as described herein. For example, the communications manager 1020 may include a capability reporting manager 1025, a measurement resource manager 1030, a measurement report manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability reporting manager 1025 is capable of, configured to, or operable to support a means for receiving, from a UE, a capability message indicating that the UE supports performing inter-UE CLI measurements in an uplink subband and in at least one downlink subband during one or more overlapping SBFD symbols. The measurement resource manager 1030 is capable of, configured to, or operable to support a means for transmitting, based on the capability message, a measurement resource configuration for the UE to perform the inter-UE CLI measurements in the uplink subband and in the at least one downlink subband. The measurement report manager 1035 is capable of, configured to, or operable to support a means for receiving, according to the measurement resource configuration, a measurement report message indicating a measurement result for the inter-UE CLI measurements.

Additionally, or alternatively, the communications manager 1020 may support wireless communications in accordance with examples as disclosed herein. The measurement resource manager 1030 is capable of, configured to, or operable to support a means for transmitting, to a UE, a measurement resource configuration for the UE to perform inter-UE CLI measurements during one or more overlapping SBFD symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing. The measurement report manager 1035 is capable of, configured to, or operable to support a means for receiving a measurement report message indicating a measurement result for the inter-UE CLI measurements.

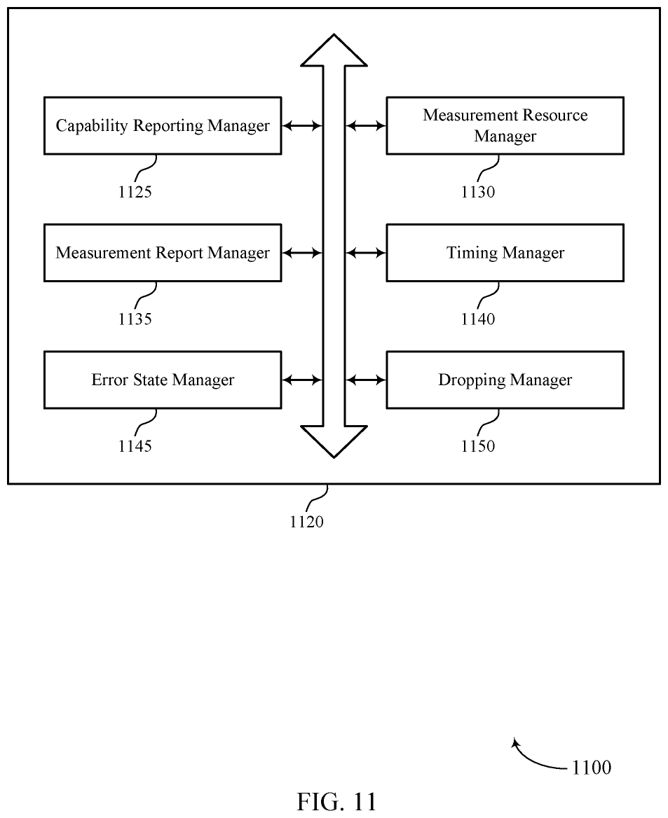

FIG. 11 shows a block diagram 1100 of a communications manager 1120 that supports CLI measurement timing for uplink and downlink subbands in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of CLI measurement timing for uplink and downlink subbands as described herein. For example, the communications manager 1120 may include a capability reporting manager 1125, a measurement resource manager 1130, a measurement report manager 1135, a timing manager 1140, an error state manager 1145, a dropping manager 1150, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability reporting manager 1125 is capable of, configured to, or operable to support a means for receiving, from a UE, a capability message indicating that the UE supports performing inter-UE CLI measurements in an uplink subband and in at least one downlink subband during one or more overlapping SBFD symbols. The measurement resource manager 1130 is capable of, configured to, or operable to support a means for transmitting, based on the capability message, a measurement resource configuration for the UE to perform the inter-UE CLI measurements in the uplink subband and in the at least one downlink subband. The measurement report manager 1135 is capable of, configured to, or operable to support a means for receiving, according to the measurement resource configuration, a measurement report message indicating a measurement result for the inter-UE CLI measurements.

In some examples, the inter-UE CLI measurements in the uplink subband is in accordance with an uplink timing associated with the uplink subband and performing the inter-UE CLI measurements in the at least one downlink subband is in accordance with a downlink timing associated with the at least one downlink subband, the uplink timing being different from the downlink timing. In some examples, the inter-UE CLI measurements in the uplink subband and in the at least one downlink subband is in accordance with one or more measurement windows associated with the uplink subband and the at least one downlink subband.

Additionally, or alternatively, the communications manager 1120 may support wireless communications in accordance with examples as disclosed herein. In some examples, the measurement resource manager 1130 is capable of, configured to, or operable to support a means for transmitting, to a UE, a measurement resource configuration for the UE to perform inter-UE CLI measurements during one or more overlapping SBFD symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing. In some examples, the measurement report manager 1135 is capable of, configured to, or operable to support a means for receiving a measurement report message indicating a measurement result for the inter-UE CLI measurements.

In some examples, the timing manager 1140 is capable of, configured to, or operable to support a means for allocating a set of preceding gap symbols before the one or more overlapping SBFD symbols for the UE to switch from the downlink timing to the uplink timing to perform the inter-UE CLI measurements in the uplink subband and in the at least one downlink subband. In some examples, the timing manager 1140 is capable of, configured to, or operable to support a means for allocating a set of trailing gap symbols before the one or more overlapping SBFD symbols for the UE to switch from the uplink timing to the downlink timing to perform the inter-UE CLI measurements in the uplink subband and in the at least one downlink subband. In some examples, the timing manager 1140 is capable of, configured to, or operable to support a means for removing a set of preceding gap symbols in accordance with the UE performing the inter-UE CLI measurements according to the downlink timing.

In some examples, the error state manager 1145 is capable of, configured to, or operable to support a means for detecting an error state in accordance with the measurement resource configuration being transmitted for inter-UE CLI measurements in the uplink subband and in the at least one downlink subband during the one or more overlapping SBFD symbols, the error state corresponding to an expectation that the UE is not to receive the measurement resource configuration for performing simultaneous inter-UE CLI measurements in the uplink subband and in the at least one downlink subband during the one or more overlapping SBFD symbols.

In some examples, the error state manager 1145 is capable of, configured to, or operable to support a means for dropping the measurement resource configuration in accordance with an expectation that the UE is not to receive the measurement resource configuration for performing the inter-UE CLI measurements in the uplink subband and in the at least one downlink subband during the one or more overlapping SBFD symbols.

In some examples, the dropping manager 1150 is capable of, configured to, or operable to support a means for transmitting an indication for the UE to drop the inter-UE CLI measurements in the uplink subband or in the at least one downlink subband, the indication in accordance with an expectation that the UE is not to receive the measurement resource configuration for performing the inter-UE CLI measurements in the uplink subband and in the at least one downlink subband during the one or more overlapping SBFD symbols.

In some examples, the timing manager 1140 is capable of, configured to, or operable to support a means for transmitting an indication for the UE to use the uplink timing or the downlink timing for the inter-UE CLI measurements in the uplink subband, in the at least one downlink subband, or both, the indication in accordance with the UE not supporting simultaneous CLI measurements in the uplink subband and in the at least one downlink subband during the one or more overlapping SBFD symbols.

In some examples, the timing manager 1140 is capable of, configured to, or operable to support a means for identifying an overlap between one or more uplink subband measurement instances and one or more downlink subband measurement instances according to the measurement resource configuration, where the UE performing the inter-UE CLI measurements in the uplink subband, in the at least one downlink subband, or both, is in accordance with the overlap.

In some examples, the timing manager 1140 is capable of, configured to, or operable to support a means for identifying a first periodicity for the inter-UE CLI measurements in the uplink subband and a second periodicity for the inter-UE CLI measurements in the at least one downlink subband, where the overlap is in accordance with the first periodicity and the second periodicity.

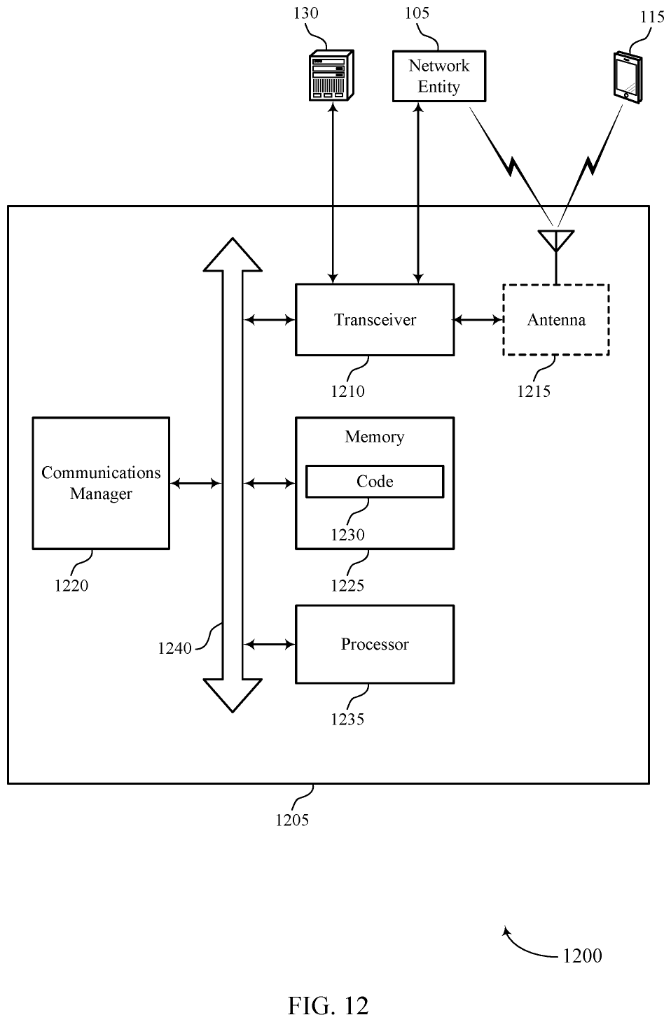

FIG. 12 shows a diagram of a system 1200 including a device 1205 that supports CLI measurement timing for uplink and downlink subbands in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting CLI measurement timing for uplink and downlink subbands). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a UE, a capability message indicating that the UE supports performing inter-UE CLI measurements in an uplink subband and in at least one downlink subband during one or more overlapping SBFD symbols. The communications manager 1220 is capable of, configured to, or operable to support a means for transmitting, based on the capability message, a measurement resource configuration for the UE to perform the inter-UE CLI measurements in the uplink subband and in the at least one downlink subband. The communications manager 1220 is capable of, configured to, or operable to support a means for receiving, according to the measurement resource configuration, a measurement report message indicating a measurement result for the inter-UE CLI measurements.

Additionally, or alternatively, the communications manager 1220 may support wireless communications in accordance with examples as disclosed herein. For example, the communications manager 1220 is capable of, configured to, or operable to support a means for transmitting, to a UE, a measurement resource configuration for the UE to perform inter-UE CLI measurements during one or more overlapping SBFD symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing. The communications manager 1220 is capable of, configured to, or operable to support a means for receiving a measurement report message indicating a measurement result for the inter-UE CLI measurements.

By including or configuring the communications manager 1220 in accordance with examples as described herein, the device 1205 may support techniques for enabling and/or otherwise supporting simultaneous inter-UE CLI measurements in the uplink subband and in at least one downlink subband. This may enable a SBFD aware UE receiving a measurement resource configuration to for such simultaneous measurements to perform, at least to some degree, the CLI measurements and report the measurement results.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of CLI measurement timing for uplink and downlink subbands as described herein, or the at least one processor 1235 and the at least one memory 1225 may be otherwise configured to, individually or collectively, perform or support such operations.

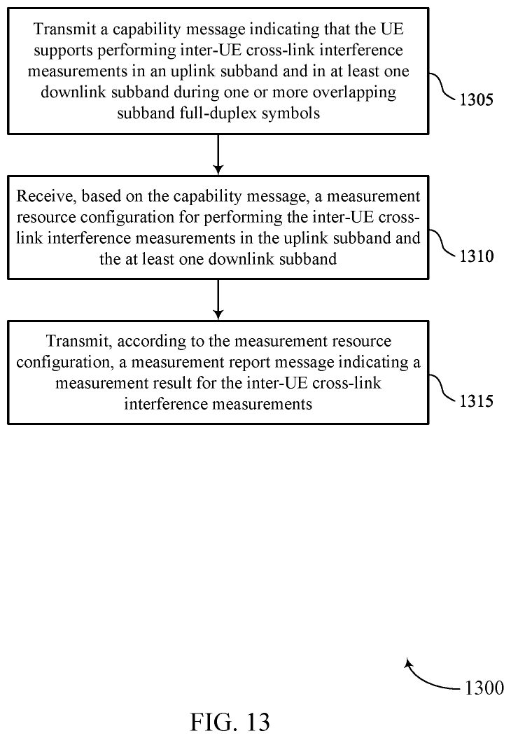

FIG. 13 shows a flowchart illustrating a method 1300 that supports CLI measurement timing for uplink and downlink subbands in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating that the UE supports performing inter-UE CLI measurements in an uplink subband and in at least one downlink subband during one or more overlapping SBFD symbols. The operations of block 1305 may be performed in accordance with examples as disclosed herein. In some examples, aspects of the operations of 1305 may be performed by a capability reporting manager 725 as described with reference to FIG. 7.

At 1310, the method may include receiving, based on the capability message, a measurement resource configuration for performing the inter-UE CLI measurements in the uplink subband and the at least one downlink subband. The operations of block 1310 may be performed in accordance with examples as disclosed herein. In some examples, aspects of the operations of 1310 may be performed by a measurement resource manager 730 as described with reference to FIG. 7.

At 1315, the method may include transmitting, according to the measurement resource configuration, a measurement report message indicating a measurement result for the inter-UE CLI measurements. The operations of block 1315 may be performed in accordance with examples as disclosed herein. In some examples, aspects of the operations of 1315 may be performed by a measurement report manager 735 as described with reference to FIG. 7.

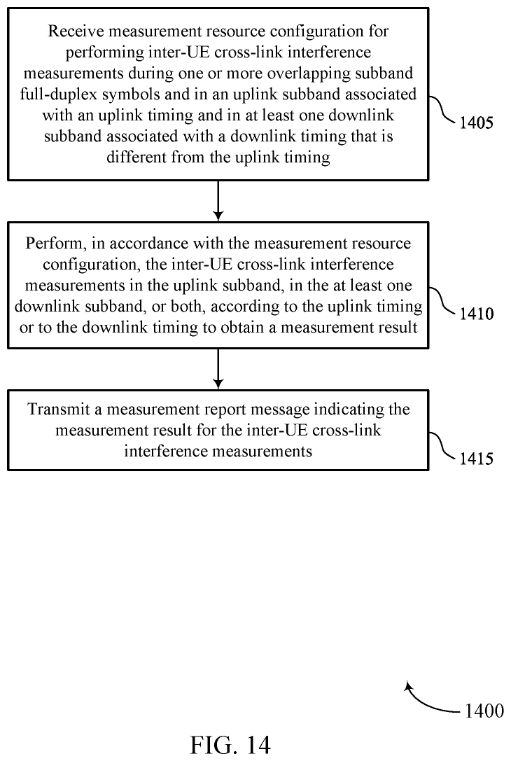

FIG. 14 shows a flowchart illustrating a method 1400 that supports CLI measurement timing for uplink and downlink subbands in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving measurement resource configuration for performing inter-UE CLI measurements during one or more overlapping SBFD symbols and in an uplink subband associated with an uplink timing and in at least one downlink subband associated with a downlink timing that is different from the uplink timing. The operations of block 1405 may be performed in accordance with examples as disclosed herein. In some examples, aspects of the operations of 1405 may be performed by a measurement resource manager 730 as described with reference to FIG. 7.

At 1410, the method may include performing, in accordance with the measurement resource configuration, the inter-UE CLI measurements in the uplink subband, in the at least one downlink subband, or both, according to the uplink timing or to the downlink timing to obtain a measurement result. The operations of block 1410 may be performed in accordance with examples as disclosed herein. In some examples, aspects of the operations of 1410 may be performed by a CLI measurement manager 740 as described with reference to FIG. 7.

At 1415, the method may include transmitting a measurement report message indicating the measurement result for the inter-UE CLI measurements. The operations of block 1415 may be performed in accordance with examples as disclosed herein. In some examples, aspects of the operations of 1415 may be performed by a measurement report manager 735 as described with reference to FIG. 7.

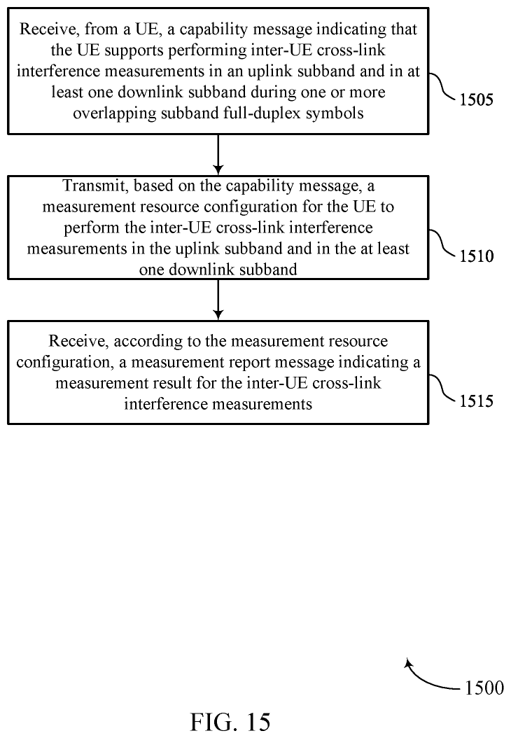

FIG. 15 shows a flowchart illustrating a method 1500 that supports CLI measurement timing for uplink and downlink subbands in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, a capability message indicating that the UE supports performing inter-UE CLI measurements in an uplink subband and in at least one downlink subband during one or more overlapping SBFD symbols. The operations of block 1505 may be performed in accordance with examples as disclosed herein. In some examples, aspects of the operations of 1505 may be performed by a capability reporting manager 1125 as described with reference to FIG. 11.

At 1510, the method may include transmitting, based on the capability message, a measurement resource configuration for the UE to perform the inter-UE CLI measurements in the uplink subband and in the at least one downlink subband. The operations of block 1510 may be performed in accordance with examples as disclosed herein. In some examples, aspects of the operations of 1510 may be performed by a measurement resource manager 1130 as described with reference to FIG. 11.

At 1515, the method may include receiving, according to the measurement resource configuration, a measurement report message indicating a measurement result for the inter-UE CLI measurements. The operations of block 1515 may be performed in accordance with examples as disclosed herein. In some examples, aspects of the operations of 1515 may be performed by a measurement report manager 1135 as described with reference to FIG. 11.

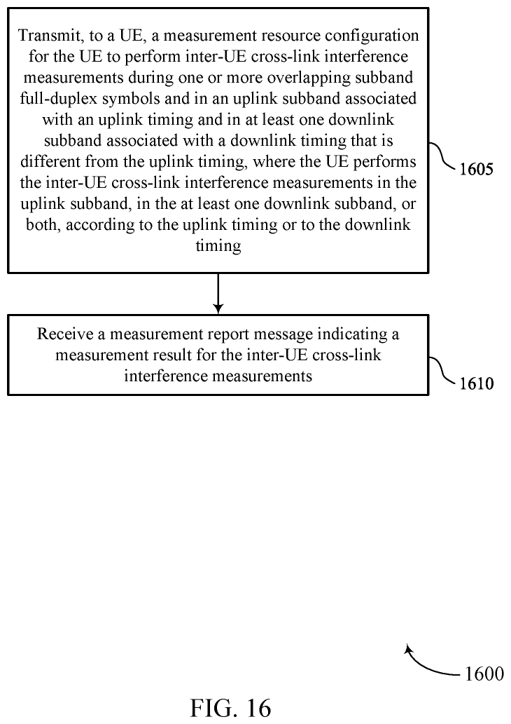

FIG. 16 shows a flowchart illustrating a method 1600 that supports CLI measurement timing for uplink and downlink subbands in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a measurement resource configuration for the UE to perform inter-UE CLI measurements during one or more overlapping SBFD symbols and in an uplink subband associated with an uplink timing and in at least one downlink subband associated with a downlink timing that is different from the uplink timing, where the UE performs the inter-UE CLI measurements in the uplink subband, in the at least one downlink subband, or both, according to the uplink timing or to the downlink timing. The operations of block 1605 may be performed in accordance with examples as disclosed herein. In some examples, aspects of the operations of 1605 may be performed by a measurement resource manager 1130 as described with reference to FIG. 11.

At 1610, the method may include receiving a measurement report message indicating a measurement result for the inter-UE CLI measurements. The operations of block 1610 may be performed in accordance with examples as disclosed herein. In some examples, aspects of the operations of 1610 may be performed by a measurement report manager 1135 as described with reference to FIG. 11.

The following provides an overview of aspects of the present disclosure:

Aspect 1: A method for wireless communications at a UE, comprising: transmitting a capability message indicating that the UE supports performing inter-UE CLI measurements in an uplink subband and in at least one downlink subband during one or more overlapping subband full-duplex symbols; receiving, based at least in part on the capability message, a measurement resource configuration for performing the inter-UE CLI measurements in the uplink subband and the at least one downlink subband; and transmitting, according to the measurement resource configuration, a measurement report message indicating a measurement result for the inter-UE CLI measurements.

Aspect 2: The method of aspect 1, further comprising: performing the inter-UE CLI measurements in the uplink subband and in the at least one downlink subband during the one or more overlapping subband full-duplex symbols to obtain the measurement result.

Aspect 3: The method of aspect 2, wherein performing the inter-UE CLI measurements in the uplink subband is in accordance with an uplink timing associated with the uplink subband and performing the inter-UE CLI measurements in the at least one downlink subband is in accordance with a downlink timing associated with the at least one downlink subband, the uplink timing being different from the downlink timing.

Aspect 4: The method of any of aspects 2 through 3, wherein performing the inter-UE CLI measurements in the uplink subband and in the at least one downlink subband is in accordance with one or more measurement windows associated with the uplink subband and the at least one downlink subband.

Aspect 5: The method of any of aspects 1 through 4, wherein the one or more overlapping subband full-duplex symbols are associated with subband full-duplex communications using the uplink subband and the at least one downlink subband.

Aspect 6: A method for wireless communications at a UE, comprising: receiving measurement resource configuration for performing inter-UE CLI measurements during one or more overlapping subband full-duplex symbols and in an uplink subband associated with an uplink timing and in at least one downlink subband associated with a downlink timing that is different from the uplink timing; performing, in accordance with the measurement resource configuration, the inter-UE CLI measurements in the uplink subband, in the at least one downlink subband, or both, according to the uplink timing or to the downlink timing to obtain a measurement result; and transmitting a measurement report message indicating the measurement result for the inter-UE CLI measurements.

Aspect 7: The method of aspect 6, wherein performing the inter-UE CLI measurements comprises: performing the inter-UE CLI measurements in the uplink subband and in the at least one downlink subband according to the uplink timing.

Aspect 8: The method of aspect 7, further comprising: switching, during a set of preceding gap symbols, from the downlink timing to the uplink timing to perform the inter-UE CLI measurements in the uplink subband and in the at least one downlink subband.

Aspect 9: The method of any of aspects 7 through 8, wherein performing the inter-UE CLI measurements comprises: measuring, using the uplink timing, a first RSSI in the at least one downlink subband, a RSRP in the uplink subband, a second RSSI in the uplink subband, or a combination thereof.

Aspect 10: The method of any of aspects 7 through 9, further comprising: performing the inter-UE CLI measurements according to the uplink timing is based on timing rule associated with the UE.

Aspect 11: The method of any of aspects 6 through 10, wherein performing the inter-UE CLI measurements comprises: performing the inter-UE CLI measurements in the uplink subband and in the at least one downlink subband according to the downlink timing.

Aspect 12: The method of aspect 11, further comprising: switching, during a set of trailing gap symbols, from the uplink timing to the downlink timing to perform the inter-UE CLI measurements in the uplink subband and in the at least one downlink subband.

Aspect 13: The method of any of aspects 11 through 12, wherein performing the inter-UE CLI measurements comprises: measuring, using the downlink timing, a first RSSI in the at least one downlink subband, a second RSSI in the uplink subband, or a combination thereof.

Aspect 14: The method of any of aspects 11 through 13, wherein a set of preceding gap symbols are removed in accordance with performing the inter-UE CLI measurements according to the downlink timing.

Aspect 15: The method of any of aspects 11 through 14, wherein performing the inter-UE CLI measurements according to the downlink timing is based on timing rule associated with the UE.

Aspect 16: The method of any of aspects 6 through 15, wherein performing the inter-UE CLI measurements comprises: dropping the inter-UE CLI measurements in the at least one downlink subband in accordance with the downlink timing being different from the uplink timing; and performing the inter-UE CLI measurements in the uplink subband according to the uplink timing.

Aspect 17: The method of aspect 16, wherein performing the inter-UE CLI measurements comprises: measuring, using the uplink timing and in accordance with the dropping, a RSRP in the uplink subband, a RSSI in the uplink subband, or a combination thereof.

Aspect 18: The method of any of aspects 16 through 17, wherein dropping the inter-UE CLI measurements in the at least one downlink subband is based on a dropping rule associated with the UE

Aspect 19: The method of any of aspects 6 through 18, wherein performing the inter-UE CLI measurements comprises: dropping the inter-UE CLI measurements in the uplink subband in accordance with the downlink timing being different from the uplink timing; and performing the inter-UE CLI measurements in the at least one downlink subband according to the downlink timing.

Aspect 20: The method of aspect 19, wherein performing the inter-UE CLI measurements comprises: measuring, using the downlink timing and in accordance with the dropping, a RSSI in the at least one downlink subband.

Aspect 21: The method of any of aspects 19 through 20, wherein dropping the inter-UE CLI measurements in the uplink subband is based on a dropping rule associated with the UE.

Aspect 22: The method of any of aspects 6 through 21, wherein performing the inter-UE CLI measurements comprises: detecting an error state in accordance with the measurement resource configuration being received for inter-UE CLI measurements in the uplink subband and the at least one downlink subband during the one or more overlapping subband full-duplex symbols, the error state corresponding to an expectation that the UE is not to receive the measurement resource configuration for performing simultaneous inter-UE CLI measurements in the uplink subband and in the at least one downlink subband during the one or more overlapping subband full-duplex symbols, wherein performing the inter-UE CLI measurements and transmitting the measurement report message are in accordance with the error state.

Aspect 23: The method of any of aspects 6 through 22, wherein performing the inter-UE CLI measurements comprises: dropping the measurement resource configuration in accordance with an expectation that the UE is not to receive CLI measurements in the uplink subband and in the at least one downlink subband during the one or more overlapping subband full-duplex symbols, wherein performing the inter-UE CLI measurements and transmitting the measurement report message are in accordance with the dropping.

Aspect 24: The method of any of aspects 6 through 23, wherein performing the inter-UE CLI measurements comprises: receiving an indication to drop the inter-UE CLI measurements in the uplink subband or in the at least one downlink subband, the indication in accordance with the UE not supporting simultaneous CLI measurements in the uplink subband and in the at least one downlink subband during the one or more overlapping subband full-duplex symbols.

Aspect 25: The method of any of aspects 6 through 24, wherein performing the inter-UE CLI measurements comprises: receiving an indication to use the uplink timing or the downlink timing for the inter-UE CLI measurements in the uplink subband, in the at least one downlink subband, or both, the indication in accordance with the UE not supporting simultaneous inter-UE CLI measurements in the uplink subband and in the at least one downlink subband during the one or more overlapping subband full-duplex symbols.

Aspect 26: The method of any of aspects 6 through 25, further comprising: identifying an overlap between one or more uplink subband measurement instances and one or more downlink subband measurement instances according to the measurement resource configuration, wherein performing the inter-UE CLI measurements in the uplink subband, in the at least one downlink subband, or both, is in accordance with the overlap.

Aspect 27: The method of aspect 26, further comprising: identifying a first periodicity for the inter-UE CLI measurements in the uplink subband and a second periodicity for the inter-UE CLI measurements in the at least one downlink subband, wherein the overlap is in accordance with the first periodicity and the second periodicity.

Aspect 28: A method for wireless communications at a network entity, comprising: receiving, from a UE, a capability message indicating that the UE supports performing inter-UE CLI measurements in an uplink subband and in at least one downlink subband during one or more overlapping subband full-duplex symbols;

transmitting, based at least in part on the capability message, a measurement resource configuration for the UE to perform the inter-UE CLI measurements in the uplink subband and in the at least one downlink subband; and receiving, according to the measurement resource configuration, a measurement report message indicating a measurement result for the inter-UE CLI measurements.

Aspect 29: The method of aspect 28, wherein the inter-UE CLI measurements in the uplink subband is in accordance with an uplink timing associated with the uplink subband and performing the inter-UE CLI measurements in the at least one downlink subband is in accordance with a downlink timing associated with the at least one downlink subband, the uplink timing being different from the downlink timing.

Aspect 30: The method of any of aspects 28 through 29, wherein the inter-UE CLI measurements in the uplink subband and in the at least one downlink subband is in accordance with one or more measurement windows associated with the uplink subband and the at least one downlink subband.

Aspect 31: A method for wireless communications at a network entity, comprising: transmitting, to a UE, a measurement resource configuration for the UE to perform inter-UE CLI measurements during one or more overlapping subband full-duplex symbols and in an uplink subband associated with an uplink timing and in at least one downlink subband associated with a downlink timing that is different from the uplink timing, wherein the UE performs the inter-UE CLI measurements in the uplink subband, in the at least one downlink subband, or both, according to the uplink timing or to the downlink timing; and receiving a measurement report message indicating a measurement result for the inter-UE CLI measurements.

Aspect 32: The method of aspect 31, further comprising: allocating a set of preceding gap symbols before the one or more overlapping subband full-duplex symbols for the UE to switch from the downlink timing to the uplink timing to perform the inter-UE CLI measurements in the uplink subband and in the at least one downlink subband.

Aspect 33: The method of any of aspects 31 through 32, further comprising: allocating a set of trailing gap symbols before the one or more overlapping subband full-duplex symbols for the UE to switch from the uplink timing to the downlink timing to perform the inter-UE CLI measurements in the uplink subband and in the at least one downlink subband.

Aspect 34: The method of aspect 33, further comprising: removing a set of preceding gap symbols in accordance with the UE performing the inter-UE CLI measurements according to the downlink timing.

Aspect 35: The method of any of aspects 31 through 34, further comprising: detecting an error state in accordance with the measurement resource configuration being transmitted for inter-UE CLI measurements in the uplink subband and in the at least one downlink subband during the one or more overlapping subband full-duplex symbols, the error state corresponding to an expectation that the UE is not to receive the measurement resource configuration for performing simultaneous inter-UE CLI measurements in the uplink subband and in the at least one downlink subband during the one or more overlapping subband full-duplex symbols.

Aspect 36: The method of any of aspects 31 through 35, further comprising: dropping the measurement resource configuration in accordance with an expectation that the UE is not to receive the measurement resource configuration for performing the inter-UE CLI measurements in the uplink subband and in the at least one downlink subband during the one or more overlapping subband full-duplex symbols.

Aspect 37: The method of any of aspects 31 through 36, further comprising: transmitting an indication for the UE to drop the inter-UE CLI measurements in the uplink subband or in the at least one downlink subband, the indication in accordance with an expectation that the UE is not to receive the measurement resource configuration for performing the inter-UE CLI measurements in the uplink subband and in the at least one downlink subband during the one or more overlapping subband full-duplex symbols.

Aspect 38: The method of any of aspects 31 through 37, further comprising: transmitting an indication for the UE to use the uplink timing or the downlink timing for the inter-UE CLI measurements in the uplink subband, in the at least one downlink subband, or both, the indication in accordance with the UE not supporting simultaneous CLI measurements in the uplink subband and in the at least one downlink subband during the one or more overlapping subband full-duplex symbols.

Aspect 39: The method of any of aspects 31 through 38, further comprising: identifying an overlap between one or more uplink subband measurement instances and one or more downlink subband measurement instances according to the measurement resource configuration, wherein the UE performing the inter-UE CLI measurements in the uplink subband, in the at least one downlink subband, or both, is in accordance with the overlap.

Aspect 40: The method of aspect 39, further comprising: identifying a first periodicity for the inter-UE CLI measurements in the uplink subband and a second periodicity for the inter-UE CLI measurements in the at least one downlink subband, wherein the overlap is in accordance with the first periodicity and the second periodicity.

Aspect 41: A UE for wireless communications, comprising one or more memories storing processor-executable code, and one or more processors coupled with the one or more memories and individually or collectively operable to execute the code to cause the UE to perform a method of any of aspects 1 through 5.

Aspect 42: A UE for wireless communications, comprising at least one means for performing a method of any of aspects 1 through 5.

Aspect 43: A non-transitory computer-readable medium storing code for wireless communications, the code comprising instructions executable by a processor to perform a method of any of aspects 1 through 5.

Aspect 44: A UE for wireless communications, comprising one or more memories storing processor-executable code, and one or more processors coupled with the one or more memories and individually or collectively operable to execute the code to cause the UE to perform a method of any of aspects 6 through 27.

Aspect 45: A UE for wireless communications, comprising at least one means for performing a method of any of aspects 6 through 27.

Aspect 46: A non-transitory computer-readable medium storing code for wireless communications, the code comprising instructions executable by a processor to perform a method of any of aspects 6 through 27.

Aspect 47: A network entity for wireless communications, comprising one or more memories storing processor-executable code, and one or more processors coupled with the one or more memories and individually or collectively operable to execute the code to cause the network entity to perform a method of any of aspects 28 through 30.

Aspect 48: A network entity for wireless communications, comprising at least one means for performing a method of any of aspects 28 through 30.

Aspect 49: A non-transitory computer-readable medium storing code for wireless communications, the code comprising instructions executable by a processor to perform a method of any of aspects 28 through 30.

Aspect 50: A network entity for wireless communications, comprising one or more memories storing processor-executable code, and one or more processors coupled with the one or more memories and individually or collectively operable to execute the code to cause the network entity to perform a method of any of aspects 31 through 40.

Aspect 51: A network entity for wireless communications, comprising at least one means for performing a method of any of aspects 31 through 40.

Aspect 52: A non-transitory computer-readable medium storing code for wireless communications, the code comprising instructions executable by a processor to perform a method of any of aspects 31 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability message indicating that the UE supports performing inter-UE cross-link interference measurements in an uplink subband and in at least one downlink subband during one or more overlapping subband full-duplex symbols;
receive, based at least in part on the capability message, a measurement resource configuration for performing the inter-UE cross-link interference measurements in the uplink subband and the at least one downlink subband; and
transmit, according to the measurement resource configuration, a measurement report message indicating a measurement result for the inter-UE cross-link interference measurements.

2. The UE of claim 1, wherein the one or more processors are individually or collectively further operable to execute the code to cause the UE to:
perform the inter-UE cross-link interference measurements in the uplink subband and in the at least one downlink subband during the one or more overlapping subband full-duplex symbols to obtain the measurement result.

3. The UE of claim 2, wherein performing the inter-UE cross-link interference measurements in the uplink subband is in accordance with an uplink timing associated with the uplink subband and performing the inter-UE cross-link interference measurements in the at least one downlink subband is in accordance with a downlink timing associated with the at least one downlink subband, the uplink timing being different from the downlink timing.

4. The UE of claim 2, wherein performing the inter-UE cross-link interference measurements in the uplink subband and in the at least one downlink subband is in accordance with one or more measurement windows associated with the uplink subband and the at least one downlink subband.

5. The UE of claim 1, wherein the one or more overlapping subband full-duplex symbols are associated with subband full-duplex communications using the uplink subband and the at least one downlink subband.

6. A user equipment (UE), comprising:
one or more memories storing processor-executable code; and
one or more processors coupled with the one or more memories and individually or collectively operable to execute the code to cause the UE to:
receive measurement resource configuration for performing inter-UE cross-link interference measurements during one or more overlapping subband full-duplex symbols and in an uplink subband associated with an uplink timing and in at least one downlink subband associated with a downlink timing that is different from the uplink timing;
perform, in accordance with the measurement resource configuration, the inter-UE cross-link interference measurements in the uplink subband, in the at least one downlink subband, or both, according to the uplink timing or to the downlink timing to obtain a measurement result; and
transmit a measurement report message indicating the measurement result for the inter-UE cross-link interference measurements.

7. The UE of claim 6, wherein, to perform the inter-UE cross-link interference measurements, the one or more processors are individually or collectively operable to execute the code to cause the UE to:
perform the inter-UE cross-link interference measurements in the uplink subband and in the at least one downlink subband according to the uplink timing.

8. The UE of claim 7, wherein the one or more processors are individually or collectively further operable to execute the code to cause the UE to:
switching, during a set of precede gap symbols, from the downlink timing to the uplink timing to perform the inter-UE cross-link interference measurements in the uplink subband and in the at least one downlink subband.

9. The UE of claim 7, wherein, to perform the inter-UE cross-link interference measurements, the one or more processors are individually or collectively operable to execute the code to cause the UE to:
measure, using the uplink timing, a first reference signal strength indicator (RSSI) in the at least one downlink subband, a reference signal receive power (RSRP) in the uplink subband, a second RSSI in the uplink subband, or a combination thereof.

10. The UE of claim 7, wherein the one or more processors are individually or collectively further operable to execute the code to cause the UE to:
perform the inter-UE cross-link interference measurements according to the uplink timing is based on a timing rule associated with the UE.

11. The UE of claim 6, wherein, to perform the inter-UE cross-link interference measurements, the one or more processors are individually or collectively operable to execute the code to cause the UE to:
perform the inter-UE cross-link interference measurements in the uplink subband and in the at least one downlink subband according to the downlink timing.

12. The UE of claim 11, wherein the one or more processors are individually or collectively further operable to execute the code to cause the UE to:
switching, during a set of trail gap symbols, from the uplink timing to the downlink timing to perform the inter-UE cross-link interference measurements in the uplink subband and in the at least one downlink subband.

13. The UE of claim 11, wherein, to perform the inter-UE cross-link interference measurements, the one or more processors are individually or collectively operable to execute the code to cause the UE to:
measure, using the downlink timing, a first reference signal strength indicator (RSSI) in the at least one downlink subband, a second RSSI in the uplink subband, or a combination thereof.

14. The UE of claim 11, wherein a set of preceding gap symbols are removed in accordance with performing the inter-UE cross-link interference measurements according to the downlink timing.

15. The UE of claim 6, wherein, to perform the inter-UE cross-link interference measurements, the one or more processors are individually or collectively operable to execute the code to cause the UE to:
drop the inter-UE cross-link interference measurements in the at least one downlink subband in accordance with the downlink timing being different from the uplink timing; and
perform the inter-UE cross-link interference measurements in the uplink subband according to the uplink timing.

16. The UE of claim 15, wherein, to perform the inter-UE cross-link interference measurements, the one or more processors are individually or collectively operable to execute the code to cause the UE to:
measure, using the uplink timing and in accordance with the dropping, a reference signal receive power (RSRP) in the uplink subband, a reference signal strength indicator (RSSI) in the uplink subband, or a combination thereof.

17. The UE of claim 6, wherein, to perform the inter-UE cross-link interference measurements, the one or more processors are individually or collectively operable to execute the code to cause the UE to:
drop the inter-UE cross-link interference measurements in the uplink subband in accordance with the downlink timing being different from the uplink timing; and
perform the inter-UE cross-link interference measurements in the at least one downlink subband according to the downlink timing.

18. The UE of claim 17, wherein, to perform the inter-UE cross-link interference measurements, the one or more processors are individually or collectively operable to execute the code to cause the UE to:
measure, using the downlink timing and in accordance with the dropping, a reference signal strength indicator (RSSI) in the at least one downlink subband.

19. The UE of claim 6, wherein, to perform the inter-UE cross-link interference measurements, the one or more processors are individually or collectively operable to execute the code to cause the UE to:
detect an error state in accordance with the measurement resource configuration being received for inter-UE cross-link interference measurements in the uplink subband and the at least one downlink subband during the one or more overlapping subband full-duplex symbols, the error state corresponding to an expectation that the UE is not to receive the measurement resource configuration for performing simultaneous inter-UE cross-link interference measurements in the uplink subband and in the at least one downlink subband during the one or more overlapping subband full-duplex symbols, wherein performing the inter-UE cross-link interference measurements and transmitting the measurement report message are in accordance with the error state.

20. The UE of claim 6, wherein, to perform the inter-UE cross-link interference measurements, the one or more processors are individually or collectively operable to execute the code to cause the UE to:
drop the measurement resource configuration in accordance with an expectation that the UE is not to receive cross-link interference measurements in the uplink subband and in the at least one downlink subband during the one or more overlapping subband full-duplex symbols, wherein performing the inter-UE cross-link interference measurements and transmitting the measurement report message are in accordance with the dropping.

21. The UE of claim 6, wherein, to perform the inter-UE cross-link interference measurements, the one or more processors are individually or collectively operable to execute the code to cause the UE to:
receive an indication to drop the inter-UE cross-link interference measurements in the uplink subband or in the at least one downlink subband, the indication in accordance with the UE not supporting simultaneous cross-link interference measurements in the uplink subband and in the at least one downlink subband during the one or more overlapping subband full-duplex symbols.

22. The UE of claim 6, wherein, to perform the inter-UE cross-link interference measurements, the one or more processors are individually or collectively operable to execute the code to cause the UE to:
receive an indication to use the uplink timing or the downlink timing for the inter-UE cross-link interference measurements in the uplink subband, in the at least one downlink subband, or both, the indication in accordance with the UE not supporting simultaneous inter-UE cross-link interference measurements in the uplink subband and in the at least one downlink subband during the one or more overlapping subband full-duplex symbols.

23. The UE of claim 6, wherein the one or more processors are individually or collectively further operable to execute the code to cause the UE to:
identify an overlap between one or more uplink subband measurement instances and one or more downlink subband measurement instances according to the measurement resource configuration, wherein performing the inter-UE cross-link interference measurements in the uplink subband, in the at least one downlink subband, or both, is in accordance with the overlap.

24. The UE of claim 23, wherein the one or more processors are individually or collectively further operable to execute the code to cause the UE to:
identify a first periodicity for the inter-UE cross-link interference measurements in the uplink subband and a second periodicity for the inter-UE cross-link interference measurements in the at least one downlink subband, wherein the overlap is in accordance with the first periodicity and the second periodicity.

25. A network entity, comprising:
one or more memories storing processor-executable code; and
one or more processors coupled with the one or more memories and individually or collectively operable to execute the code to cause the network entity to:
receive, from a user equipment (UE), a capability message indicating that the UE supports performing inter-UE cross-link interference measurements in an uplink subband and in at least one downlink subband during one or more overlapping subband full-duplex symbols;
transmit, based at least in part on the capability message, a measurement resource configuration for the UE to perform the inter-UE cross-link interference measurements in the uplink subband and in the at least one downlink subband; and
receive, according to the measurement resource configuration, a measurement report message indicating a measurement result for the inter-UE cross-link interference measurements.

26. The network entity of claim 25, wherein the inter-UE cross-link interference measurements in the uplink subband is in accordance with an uplink timing associated with the uplink subband and performing the inter-UE cross-link interference measurements in the at least one downlink subband is in accordance with a downlink timing associated with the at least one downlink subband, the uplink timing being different from the downlink timing.

27. The network entity of claim 25, wherein the inter-UE cross-link interference measurements in the uplink subband and in the at least one downlink subband is in accordance with one or more measurement windows associated with the uplink subband and the at least one downlink subband.

28. A network entity, comprising:
one or more memories storing processor-executable code; and
one or more processors coupled with the one or more memories and individually or collectively operable to execute the code to cause the network entity to:
transmit, to a user equipment (UE), a measurement resource configuration for the UE to perform inter-UE cross-link interference measurements during one or more overlapping subband full-duplex symbols and in an uplink subband associated with an uplink timing and in at least one downlink subband associated with a downlink timing that is different from the uplink timing, wherein the UE performs the inter-UE cross-link interference measurements in the uplink subband, in the at least one downlink subband, or both, according to the uplink timing or to the downlink timing; and
receive a measurement report message indicating a measurement result for the inter-UE cross-link interference measurements.

29. The network entity of claim 28, wherein the one or more processors are individually or collectively further operable to execute the code to cause the network entity to:
allocate a set of preceding gap symbols before the one or more overlapping subband full-duplex symbols for the UE to switch from the downlink timing to the uplink timing to perform the inter-UE cross-link interference measurements in the uplink subband and in the at least one downlink subband.

30. The network entity of claim 29, wherein the one or more processors are individually or collectively further operable to execute the code to cause the network entity to:
allocate a set of trailing gap symbols before the one or more overlapping subband full-duplex symbols for the UE to switch from the uplink timing to the downlink timing to perform the inter-UE cross-link interference measurements in the uplink subband and in the at least one downlink subband.
